(19) United States
(12) Patent Application Publication
(10) Pub. No.: US 2016/0092849 A1
(43) Pub. Date: Mar. 31, 2016

(54) METHODS AND SYSTEMS FOR PRICING AND PERFORMING OTHER PROCESSES ASSOCIATED WITH RECYCLING MOBILE PHONES AND OTHER ELECTRONIC DEVICES

(71) Applicant: ECOATM, INC., San Diego, CA (US)

(72) Inventors: Vanessa Cirannek, San Diego, CA (US); Jeffrey Ploetner, La Jolla, CA (US)

(21) Appl. No.: 14/498,763

(22) Filed: Sep. 26, 2014

(51) Int. Cl. G06Q 10/00; G06Q 20/18; G06Q 30/06; G06Q 30/02; G06K 9/62; H04N 5/225

(52) U.S. Cl. CPC G06Q 10/30; G06K 9/6201; H04N 5/225; G06Q 30/0611; G06Q 30/0278; G06Q 20/18

(57) ABSTRACT

The present disclosure describes various embodiments of methods and systems for developing pricing and performing other processes associated with recycling mobile phones, other consumer electronic devices, and/or other goods and services. In some embodiments, the methods and systems disclosed herein can be employed by a user-operated kiosk to determine a price to offer the user for a mobile phone or other electronic device that cannot be sufficiently identified by the kiosk. In some embodiments, the price can be an adjusted price, such as a weighted average price.

### TECHNICAL FIELD

The present disclosure is directed generally to methods and systems for recycling mobile phones and other consumer electronic devices and, more particularly, to methods and systems associated with pricing such devices.

### BACKGROUND

Consumer electronic devices, such as mobile phones, laptop computers, notebooks, tablets, MP3 players, etc., are ubiquitous. Currently there are over 6 billion mobile devices in use in the world; and this number is growing rapidly as more than 1.8 billion mobile phones were sold in 2013 alone. By 2017 it is expected that there will be more mobile devices in use than people on the planet. In addition to mobile phones, over 300 million desk-based and notebook computers shipped in 2013, and for the first time the number of tablet computers shipped exceeded laptops. Part of the reason for the rapid growth in the number of mobile phones and other electronic devices is the rapid pace at which these devices evolve, and the increased usage of such devices in developing countries.

As a result of the rapid pace of development, a relatively high percentage of electronic devices are replaced every year as consumers continually upgrade their mobile phones and other electronic devices to obtain the latest features or a better operating plan. According to the U.S. Environmental Protection Agency, consumers in the United States alone dispose of over 370 million mobile phones, PDAs, tablets, and other electronic devices every year. Millions of other outdated or broken mobile phones and other electronic devices are simply tossed into junk drawers or otherwise kept until a suitable disposal solution arises.

Although many electronic device retailers and cell carrier stores now offer mobile phone trade-in or buyback programs, many old mobile phones still end up in landfills or are improperly disassembled and disposed of in developing countries. Mobile phones and similar electronic devices, however, typically contain substances that can be harmful to the environment, such as arsenic, lithium, cadmium, copper, lead, mercury and zinc. If not properly disposed of, these toxic substances can seep into groundwater from decomposing landfills and contaminate the soil with potentiality harmful consequences for humans and the environment.

As an alternative to retailer trade-in or buyback programs, consumers can now recycle and/or sell their used mobile phones using self-service kiosks located in malls, retail stores or other publically accessible areas. Such kiosks are operated by ecoATM, Inc., the assignee of the present application, and are disclosed in, for example, U.S. Pat. Nos. 8,463,646, 8,423,404, 8,239,262, 8,200,533, 8,195,511, and 7,881,965, which are commonly owned by ecoATM, Inc. and are incorporated herein by reference in their entireties.

When offering to purchase used mobiles phones and/or other electronic devices from consumers, it can be important to offer the consumer a suitable price. If the price is too low, the consumer may decline the offer. Conversely, if the price is too high the recycler may be losing potential profits from the enterprise. Accordingly, establishing suitable prices for mobile phones and other electronic devices can be mutually advantageous to both buyer and seller, and doing so may incentivize consumers to dispose of their old electronic devices in an efficient, environmentally conscientious way.

### BRIEF DESCRIPTION OF THE DRAWINGS

FIG. 1 is an isometric view of a machine configured in accordance with an embodiment of the present technology for recycling mobile phones and/or other electronic devices.

FIGS. 2A-2D are a series of isometric views of the machine of FIG. 1 with a number of exterior panels removed to illustrate operation of the machine in accordance with an embodiment of the present technology.

FIG. 3 is a flow diagram of a routine for recycling mobile phones and/or other electronic devices in accordance with an embodiment of the present technology.

FIG. 4 illustrates a series of tables for organizing information associated with groups of electronic devices in accordance with an embodiment of the present technology.

FIG. 5 is a flow diagram of a routine for grouping electronic devices in accordance with an embodiment of the present technology.

FIGS. 6A and 6B illustrate formulas for calculating weighted average prices for electronic devices in accordance with embodiments of the present technology.

FIGS. 7A and 7B are flow diagrams of routines for determining offer prices for electronic devices in accordance with embodiments of the present technology.

FIG. 8 is a schematic diagram illustrating various components associated with the machine of FIG. 1.

FIG. 9 is a schematic diagram of a suitable distributed computing environment for implementing various aspects of the present technology.

### DETAILED DESCRIPTION

The following disclosure describes various embodiments of systems and methods for determining prices for mobile phones and other consumer electronic devices, and for performing other operations associated with electronic device recycling. Embodiments of the methods described herein can be performed by or with consumer-operated kiosks, networked processing devices, retailer-assisted machines, and/or the like. Some embodiments of the present technology, for example, are directed to consumer-operated kiosks that can perform automatic visual and/or electrical inspections of mobile phones and/or other consumer electronic devices that are submitted to the kiosks for sale or recycling. As described in greater detail below, the visual evaluation or inspection can be performed using one or more cameras or other imaging devices, and the electrical analysis can be performed using a suitable processing device connected to the subject electronic device via, e.g., a suitable electrical connector.

Often different models of electronic devices (e.g., mobile phones) may look very similar (or even identical), even though the particular devices may in fact be very different in terms of electrical components, features, etc. This is especially true in the case of a mobile phone model that has a number of different sub-models that, although appearing visually similar, may actually have a wide variety of different electrical features. Additionally, in some instances a mobile phone may not “power up” at a recycling kiosk. In such situations, it may be very difficult for the kiosk to visually and/or electrically confirm the specific type (e.g., the make, model, sub-model, electronic features, etc.) of a particular device that is being submitted for recycling/sale. Although it may be difficult (or even impossible) to positively identify some devices taken in by the kiosk, in most instances such devices will fall into groups of visually and/or electrically similar devices. For example, visually similar groups are groups of electronic devices that look the same or similar and, as a result, are difficult for the kiosk to visually distinguish from one another. By way of example, some different models of mobile phones may have the same, or at least very similar external dimensions and features, such as the same length, width, and thickness (or height) dimensions; and/or the same placement and size of display screen, buttons, connector outlets, and/or other features. Electrically similar groups are groups of devices that share the same, or generally the same, electrical identification features. Such devices may be said to have, for example, the same or a similar “electrical fingerprint.” For example, some sub-models of mobile phones and other types of electronic devices include the same product identification number (PID) and vendor identification number (VID).

Different mobile phones within a visually/electrically similar group can have very different values. For example, some of the devices in a group may include certain features that others lack, such as larger memory, greater availability of carriers, etc., and such features can greatly affect the resale price of such devices. Accordingly, it can be important to accurately identify a mobile phone (or other electronic device) before determining a price to offer the consumer for the device. As noted above, however, in some instances consumers will submit mobile phones for sale that cannot be positively identified. When this happens, one alternative is to identify the group of visually and/or electrically similar devices to which the subject device belongs, and then offer the consumer the lowest price of any device in that group to minimize the risk of paying too much for the device. If it just so happens that the price offered to the consumer reflects the real value of the device as the consumer perceives it, then the consumer may accept the offer. However, if it turns out that the device is actually a higher priced device within the group, then it is very likely that the consumer will reject the low price offer. This can lead to consumer dissatisfaction as well as lost profits for the kiosk operator. Conversely, if the kiosk pays too much for a device, this will also result in lost profits. Accordingly, offering a price that is closer to the actual value of the consumer's device can enhance customer satisfaction and maintain profit margins for the kiosk operator.

As described in greater detail below, various embodiments of the present technology are directed to methods and systems for providing the consumer (or other party wishing to sell or recycle an electronic device) a price (e.g., an average price or weighted average price) for their device that limits the risk of over or under paying for the device. In some embodiments, the weighted average price can represent an average of all device prices within a device group (e.g., a visually similar group, an electrically similar group, etc.) in which each device price is “weighted” by, for example, its relative importance. The relative importance can be measured as a ratio of the intake quantity of a particular device within a group, divided by the total intake quantity of all of the devices in the group (e.g., the “device distribution”). The intake quantities of different devices can be determined by counting the numbers of different devices taken in by one or more kiosks (e.g., a network of kiosks) after the devices have been processed (e.g., after a human has verified and accurately identified the device type). In other embodiments, the intake quantities used to develop the relative importance of particular device prices can be based on the distribution of devices from available data (e.g., available industry data), surveys, and/or other sources. In this manner, if the distribution of devices coming into the kiosks for recycling changes, or if new devices are added to a visually/electrically similar group, the weighted average price for devices within that group can automatically be adapted and adjusted accordingly (i.e., the weighted average price can be “self-correcting”). The weighted average price can thus capture the likelihood that a price offered for a certain device within a group reflects the actual value of the device. Additionally, the profit margin from a weighted average price can, in some embodiments, represent the average margin that would be generated by devices within the device group. In other embodiments, individual device prices (and/or device models, etc.) can be weighted based on other factors, such as purchase price sensitivity (e.g., device sellers in particular locations or channels (e.g., different states, malls, retail outlets, etc.) may accept different offer prices than sellers in other channels), resale value in, e.g., a particular locale or market; likelihood a device could be stolen; location of device purchase; expected product life cycle; seller demographics; etc. These and other aspects of various embodiments of the present technology are described in greater detail below.

There are a number of reasons that using the pricing methods and systems disclosed herein may be advantageous. For example, device identification and detection issues may always exist in some form because, for example, new electronic devices are being brought to market virtually every day. As this happens, automated equipment for detecting and identifying these devices may need to be “trained” to identify and evaluate the devices. Similarly, as successor device models come on the market, they may be visually similar (or identical) to predecessor devices, but may have significantly different electronic features with very disparate market values. For example, low value sub-models of a high value device can look visually similar. Additionally, one manufacturer may elect to copy the look (e.g., size, features, shape, etc.) of a popular, high-priced design of a different manufacturer. In yet other instances, manufacturers may share a design (e.g., such as a device housing or case) but differentiate their devices through various technical or electronic features.

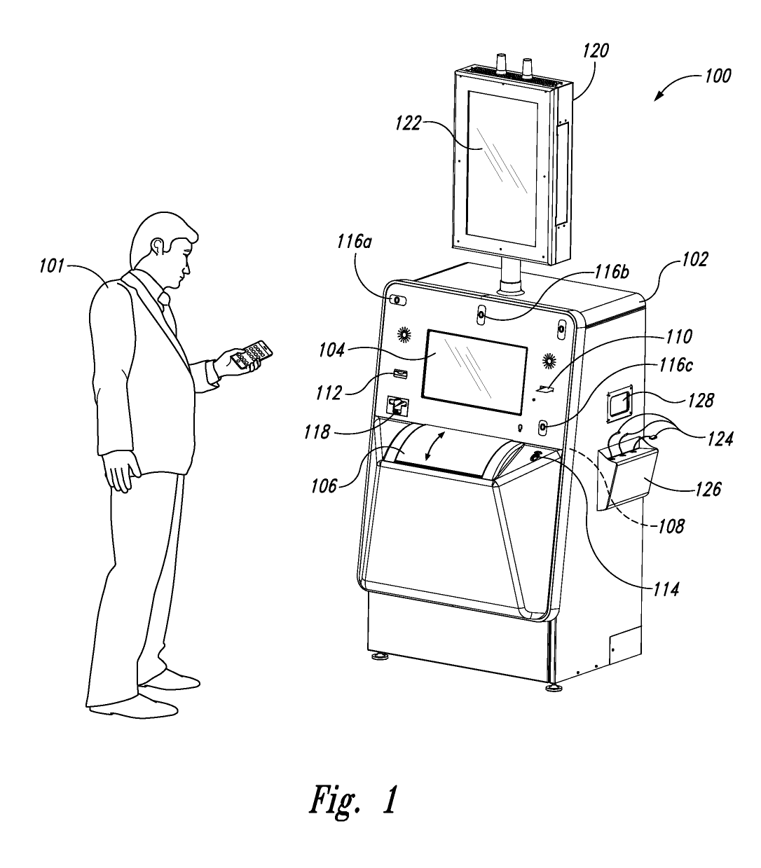

Certain details are set forth in the following description and in FIGS. 1-9 to provide a thorough understanding of various embodiments of the present technology. In other instances, well-known structures, materials, operations and/or systems often associated with smartphones and other handheld devices, consumer electronic devices, computer hardware, software, and network systems, etc. are not shown or described in detail in the following disclosure to avoid unnecessarily obscuring the description of the various embodiments of the technology. Those of ordinary skill in the art will recognize, however, that the present technology can be practiced without one or more of the details set forth herein, or with other structures, methods, components, and so forth. The terminology used below should be interpreted in its broadest reasonable manner, even though it is being used in conjunction with a detailed description of certain examples of embodiments of the technology. Indeed, certain terms may even be emphasized below; however, any terminology intended to be interpreted in any restricted manner will be specifically defined as such in this Detailed Description section.

The accompanying Figures depict embodiments of the present technology and are not intended to be limiting of its scope. The sizes of various depicted elements are not necessarily drawn to scale, and these various elements may be arbitrarily enlarged to improve legibility. Component details may be abstracted in the Figures to exclude details such as the position of components and certain precise connections between such components when such details are unnecessary for a complete understanding of how to make and use the invention.

In the Figures, identical reference numbers identify identical, or at least generally similar, elements. To facilitate the discussion of any particular element, the most significant digit or digits of any reference number refers to the Figure in which that element is first introduced. For example, element 110 is first introduced and discussed with reference to FIG. 1.

FIG. 1 is an isometric view of a kiosk 100 for recycling and/or other processing of mobile phones and other consumer electronic devices in accordance with the present technology. The term “processing” is used herein for ease of reference to generally refer to all manner of services and operations that may be performed or facilitated by the kiosk 100 on, with, or otherwise in relation to an electronic device. Such services and operations can include, for example, selling, reselling, recycling, donating, exchanging, identifying, evaluating, pricing, auctioning, decommissioning, transferring data from or to, reconfiguring, refurbishing, etc., mobile phones and other electronic devices. Although many embodiments of the present technology are described herein in the context of mobile phones, aspects of the present technology are not limited to mobile phones and generally apply to other consumer electronic devices. Such devices include, as non-limiting examples, all manner of mobile phones, smart phones, handheld devices, PDAs, MP3 players, tablet, notebook and laptop computers, e-readers, cameras, etc. In some embodiments, it is contemplated that the kiosk 100 can facilitate selling and/or otherwise processing larger consumer electronic devices, such as desktop computers, TVs, game consoles, etc., as well smaller electronic devices such as Google Glass™, smart-watches, etc. The kiosk 100 and various features thereof can be at least generally similar in structure and function to the kiosks and corresponding features described in U.S. Pat. Nos. 8,463,646, 8,423,404, 8,239,262, 8,200,533, 8,195,511, and 7,881,965; and in U.S. patent application Ser. Nos. 12/573,089, 12/727,624, 13/113,497, 12/785,465, 13/017,560, 13/438,924, 13/753,539, 13/658,825, 13/733,984, 13/705,252, 13/487,299 13/492,835, 13/562,292, 13/658,828, 13/693,032, 13/792,030, 13/794,814, 13/794,816, 13/862,395 and 13/913,408, each of which is incorporated herein in its entirety by reference. All of the patents and patent applications listed in the preceding sentence are commonly owned by the applicant of the present application, and they along with any other patents or patent applications identified herein are incorporated herein by reference in their entireties.

In the illustrated embodiment, the kiosk 100 is a floor-standing self-service kiosk configured for use by a user 101 (e.g., a consumer, customer, etc.) to recycle, sell, and/or perform other operations with a mobile phone or other consumer electronic device. In other embodiments, the kiosk 100 can be configured for use on a countertop or a similar raised surface. Although the kiosk 100 is configured for use by consumers, in various embodiments the kiosk 100 and/or various portions thereof can also be used by other operators, such as a retail clerk or kiosk assistant to facilitate the selling or other processing of mobile phones and other electronic devices.

In the illustrated embodiment, the kiosk 100 includes a housing 102 that is approximately the size of a conventional vending machine. The housing 102 can be of conventional manufacture from, for example, sheet metal, plastic panels, etc. A plurality of user interface devices are provided on a front portion of the housing 102 for providing instructions and other information to users, and/or for receiving user inputs and other information from users. For example, the kiosk 100 can include a display screen 104 (e.g., a liquid crystal display (“LCD”) or light emitting diode (“LED”) display screen, a projected display (such as a heads-up display or a head-mounted device), and so on) for providing information, prompts, etc., to users. The display screen 104 can include a touch screen for receiving user input and responses to displayed prompts. In addition or alternatively, the kiosk 100 can include a separate keyboard or keypad for this purpose. The kiosk 100 can also include an ID reader or scanner 112 (e.g., a driver's license scanner), a fingerprint reader 114, and one or more cameras 116 (e.g., digital still and/or video cameras, identified individually as cameras 116a-c). The kiosk 100 can additionally include output devices such as a label printer having an outlet 110, and a cash dispenser having an outlet 118. Although not identified in FIG. 1, the kiosk 100 can further include a speaker and/or a headphone jack for audibly communicating information to users, one or more lights for visually communicating signals or other information to users, a handset or microphone for receiving verbal input from the user, a card reader (e.g., a credit/debit card reader, loyalty card reader, etc.), a receipt or voucher printer and dispenser, as well as other user input and output devices. The input devices can include a touchpad, pointing device such as a mouse, joystick, pen, game pad, motion sensor, scanner, eye direction monitoring system, etc. Additionally the kiosk 100 can also include a bar code reader, QR code reader, bag/package dispenser, a digital signature pad, etc. In the illustrated embodiment, the kiosk 100 additionally includes a header 120 having a display screen 122 for displaying marketing advertisements and/or other video or graphical information to attract users to the kiosk. In addition to the user interface devices described above, the front portion of the housing 102 also includes an access panel or door 106 located directly beneath the display screen 104. As described in greater detail below, the access door is configured to automatically retract so that the user 101 can place an electronic device (e.g., a mobile phone) in an inspection area 108 for automatic inspection by the kiosk 100.

A sidewall portion of the housing 102 can include a number of conveniences to help users recycle or otherwise process their mobile phones. For example, in the illustrated embodiment the kiosk 100 includes an accessory bin 128 that is configured to receive mobile device accessories that the user wishes to recycle or otherwise dispose of. Additionally, the kiosk 100 can provide a free charging station 126 with a plurality of electrical connectors 124 for charging a wide variety of mobile phones and other consumer electronic devices.

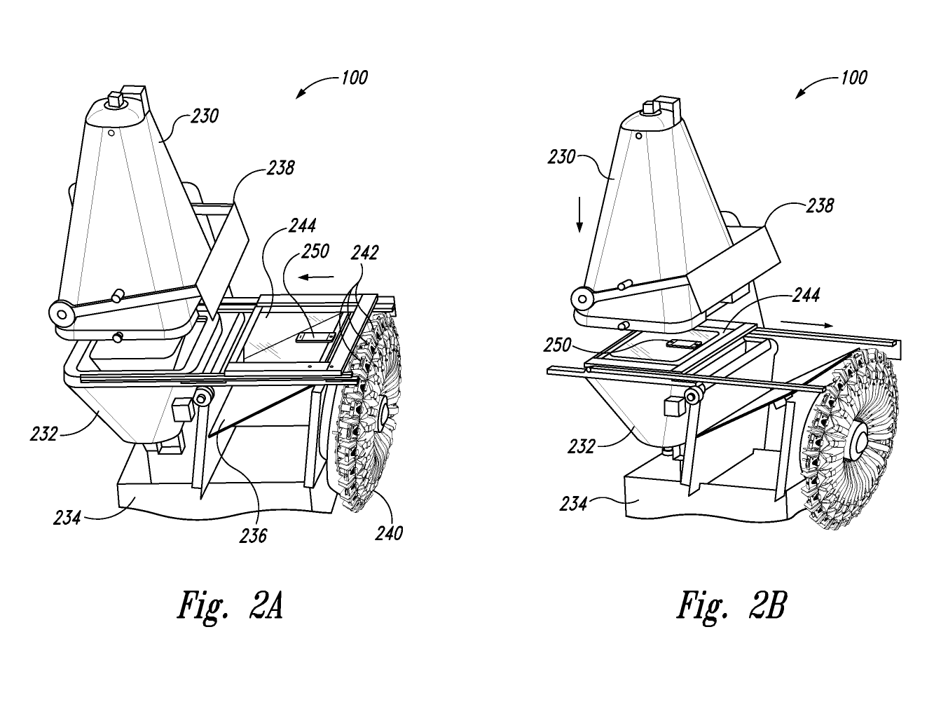

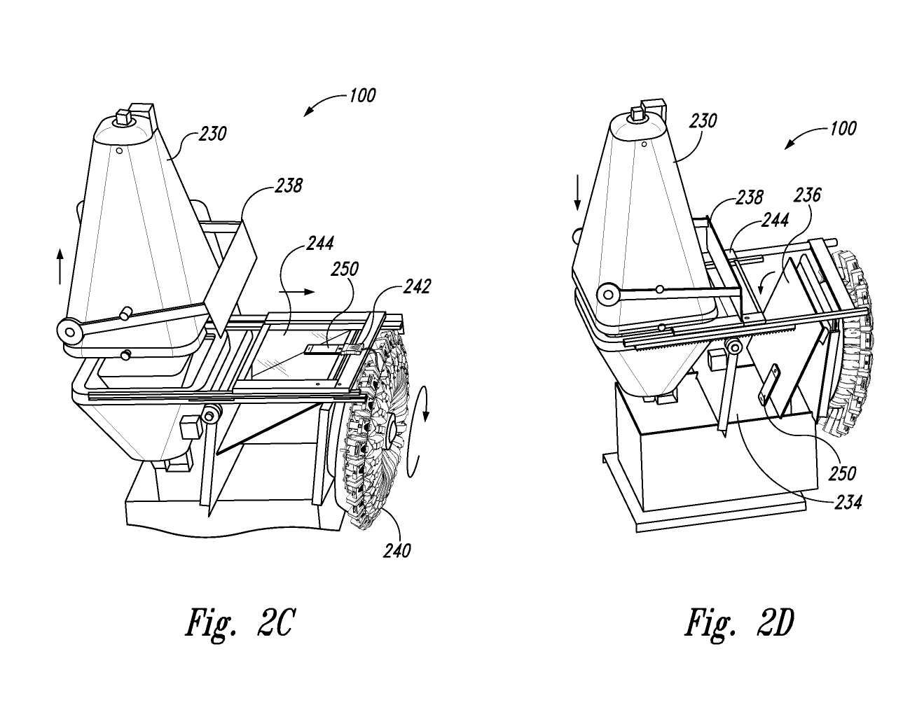

FIGS. 2A-2D are a series of isometric views of the kiosk 100 with the housing 102 removed to illustrate selected internal components configured in accordance with an embodiment of the present technology. Referring first to FIG. 2A, in the illustrated embodiment the kiosk 100 includes a connector carrier 240 and an inspection plate 244 operably disposed behind the access door 106 (FIG. 1). In the illustrated embodiment, the connector carrier 240 is a rotatable carrousel that is configured to rotate about a generally horizontal axis and carries a plurality of electrical connectors 242 (e.g., approximately 25 connectors) distributed around an outer periphery thereof. In other embodiments, other types of connector carrying devices (including both fixed and movable arrangements) can be used. In some embodiments, the connectors 242 can include a plurality of interchangeable USB connectors configured to provide power and/or exchange data with a variety of different mobile phones and/or other electronic devices. In operation, the connector carrier 240 is configured to automatically rotate about its axis to position an appropriate one of the connectors 242 adjacent to an electronic device, such as a mobile phone 250, that has been placed on the inspection plate 244 for recycling. The connector 242 can then be manually and/or automatically withdrawn from the connector carrier 240 and connected to a port on the mobile phone 250 for electrical analysis. Such analysis can include, e.g., an evaluation of the make, model, configuration, condition, etc., using one or more of the methods and/or systems described in detail in the commonly owned patents and patent applications identified herein and incorporated by reference in their entireties.

In the illustrated embodiment, the inspection plate 244 is configured to translate back and forth (on, e.g., parallel mounting tracks) to move an electronic device, such as the mobile phone 250, between a first position directly behind the access door 106 and a second position between an upper chamber 230 and an opposing lower chamber 232. Moreover, in this embodiment the inspection plate 244 is transparent, or at least partially transparent (e.g., formed of glass, Plexiglas, etc.) to enable the mobile phone 250 to be photographed and/or otherwise optically evaluated from all, or at least most viewing angles (e.g., top, bottom, sides, etc.) using, e.g., one or more cameras, mirrors, etc. mounted to or otherwise associated with the upper and lower chambers 230 and 232. When the mobile phone 250 is in the second position, the upper chamber 230 can translate downwardly to generally enclose the mobile phone 250 between the upper chamber 230 and the lower chamber 232. The upper chamber 230 is operably coupled to a gate 238 that moves up and down in unison with the upper chamber 230. As noted above, in the illustrated embodiment the upper chamber 230 and/or the lower chamber 232 can include one or more cameras, magnification tools, scanners (e.g., bar code scanners, infrared scanners, etc.) or other imaging components (not shown) and an arrangement of mirrors (also not shown) to view, photograph and/or otherwise visually evaluate the mobile phone 250 from multiple perspectives. In some embodiments, one or more of the cameras and/or other imaging components discussed above can be movable to facilitate device evaluation. The inspection area 108 can also include weight scales, heat detectors, UV readers/detectors, and the like, for further evaluation of electronic devices placed therein. The kiosk 100 can further include an angled binning plate 236 for directing electronic devices from the transparent plate 244 into a collection bin 234 positioned in a lower portion of the kiosk 100.

The kiosk 100 can be used in a number of different ways to efficiently facilitate the recycling, selling and/or other processing of mobile phones and other consumer electronic devices. Referring to FIGS. 1-2D together, in one embodiment a user wishing to sell a used mobile phone, such as the mobile phone 250, approaches the kiosk 100 and identifies the type of device the user wishes to sell in response to prompts on the display screen 104. Next, the user may be prompted to remove any cases, stickers, or other accessories from the device so that it can be accurately evaluated. Additionally, the kiosk 100 may print and dispense a unique identification label (e.g., a small adhesive-backed sticker with a quick response code (“QR code”), barcode, or other machine-readable indicia, etc.) from the label outlet 110 for the user to adhere to the back of the mobile phone 250. After this is done, the door 106 retracts and opens allowing the user to place the mobile phone 250 onto the transparent plate 244 in the inspection area 108 (FIG. 2A). The door 106 then closes and the transparent plate 244 moves the mobile phone 250 under the upper chamber 230 as shown in FIG. 2B. The upper chamber 230 then moves downwardly to generally enclose the mobile phone 250 between the upper and lower chambers 230 and 232, and the cameras and/or other imaging components in the upper and lower chambers 230 and 232 perform a visual inspection of the mobile phone 250. In some embodiments, the visual inspection can include a computer-implemented visual analysis (e.g., a three-dimensional (“3D”) analysis) performed by a processing device within the kiosk (e.g., a CPU) to confirm the identification of the mobile phone 250 (e.g. make, model and/or sub-model) and/or to evaluate or assess the condition and/or function of the mobile phone 250 and/or its various components and systems. For example, the visual analysis can include computer-implemented evaluation (e.g., a digital comparison) of images of the mobile phone 250 taken from top, side and/or end view perspectives to determine length, width, and/or height (thickness) dimensions of the mobile phone 250. The visual analysis can further include a computer-implemented inspection of a display screen on the mobile phone 250 to check for, e.g., cracks in the glass and/or other damage or defects in the LCD (e.g., defective pixels, etc.). In some embodiments, the kiosk 100 can perform the visual analysis using one or more of the methods and/or systems described in detail in the commonly owned patents and patent applications identified herein and incorporated by reference in their entireties.

Referring next to FIG. 2C, after the visual analysis is performed and the device has been identified, the upper chamber 230 returns to its upper position and the transparent plate 244 returns the mobile phone 250 to its initial position near the door 106. The display screen 104 can also provide an estimated price, or an estimated range of prices, that the kiosk 100 may offer the user for the mobile phone 250 based on the visual analysis, and/or based on user input (e.g., input regarding the type, condition, etc. of the phone 250). If the user indicates (via, e.g., input via the touch screen) that they wish to proceed with the transaction, the connector carrier 240 automatically rotates an appropriate one of the connectors 242 into position adjacent the transparent plate 244, and door 106 is again opened. The user can then be instructed (via, e.g., the display screen 104) to withdraw the selected connector 242 (and its associated wire) from the carrousel 240, plug the connector 242 into the corresponding port (e.g., a USB port) on the mobile phone 250, and reposition the mobile phone 250 in the inspection area on the transparent plate 244. After doing so, the door 106 once again closes and the kiosk 100 (e.g. the kiosk CPU) performs an electrical inspection of the device via the connector 242 to further evaluate the condition of the phone as well as specific component and operating parameters such as the memory, carrier, etc. In addition or alternatively, in some embodiments the electrical inspection can include a determination of phone manufacturer information (e.g., a vendor identification number or VID) and product information (e.g., a product identification number or PID). In some embodiments, the kiosk 100 can perform the electrical analysis using one or more of the methods and/or systems described in detail in the commonly owned patents and patent applications identified herein and incorporated by reference in their entireties.

After the visual and electronic analysis of the mobile phone 250, the user is presented with a phone purchase price via the display screen 104. If the user declines the price (via, e.g., the touch screen), a retraction mechanism (not shown) automatically disconnects the connector 242 from the mobile phone 250, the door 106 opens, and the user can reach in and retrieve the mobile phone 250. If the user accepts the price, the door 106 remains closed and the user may be prompted to place his or her identification (e.g., a driver's license) in the ID scanner 112 and provide a thumbprint via the fingerprint reader 114. As a fraud prevention measure, the kiosk 100 can be configured to transmit an image of the driver's license to a remote computer screen, and an operator at the remote computer can visually compare the picture (and/or other information) on the driver's license to an image of the person standing in front of the kiosk 100 as viewed by one or more of the cameras 116a-c (FIG. 1) to confirm that the person attempting to sell the phone 250 is in fact the person identified by the driver's license. In some embodiments, one or more of the cameras 116a-c can be movable to facilitate viewing of kiosk users, as well as other individuals in the proximity of the kiosk 100. Additionally, the person's fingerprint can be checked against records of known fraud perpetrators. If either of these checks indicate that the person selling the phone presents a fraud risk, the transaction can be declined and the mobile phone 250 returned. After the user's identity has been verified, the transparent plate 244 moves back toward the upper and lower chambers 230 and 232. As shown in FIG. 2D, however, when the upper chamber 230 is in the lower position the gate 238 permits the transparent plate 244 to slide underneath but not electronic devices carried thereon. As a result, the gate 238 knocks the mobile phone 150 off of the transparent plate 244, onto the binning plate 236 and into the bin 234. The kiosk can then provide payment of the purchase price to the user. In some embodiments, payment can be made in the form of cash dispensed from the cash outlet 118. In other embodiments, the user can receive remuneration for the mobile phone 150 in various other useful ways. For example, the user can be paid via a redeemable cash voucher, a coupon, an e-certificate, a prepaid card, a wired or wireless monetary deposit to an electronic account (e.g., a bank account, credit account, loyalty account, online commerce account, mobile wallet etc.), Bitcoin, etc.

As those of ordinary skill in the art will appreciate, the foregoing routines are but some examples of ways in which the kiosk 100 can be used to recycle or otherwise process consumer electronic devices such as mobile phones. Although the foregoing example is described in the context of mobile phones, it should be understood that the kiosk 100 and various embodiments thereof can also be used in a similar manner for recycling virtually any consumer electronic device, such as MP3 players, tablet computers, PDAs, and other portable devices, as well as other relatively non-portable electronic devices such as desktop computers, printers, devices for implementing games, entertainment or other digital media on CDs, DVDs, Blu-ray, etc. Moreover, although the foregoing example is described in the context of use by a consumer, the kiosk 100 in various embodiments thereof can similarly be used by others, such as a store clerk, to assist consumers in recycling, selling, exchanging, etc. their electronic devices.

The Figures described herein and below include representative flow diagrams and other information that depict processes used in some embodiments of the present technology. These flow diagrams may not show all functions or exchanges of data, but instead they provide an understanding of commands and data exchanged under the systems described herein. Those skilled in the relevant art will recognize that some functions or exchange of commands and data may be repeated, varied, omitted, or supplemented, and other (less important) aspects not shown may be readily implemented. Those skilled in the art will appreciate that the blocks shown in the flow diagrams discussed below may be altered in a variety of ways. For example, while processes or blocks are presented in a given order, alternative implementations may perform routines in a different order, and some processes or blocks may be rearranged, deleted, moved, added, subdivided, combined, and/or modified to provide alternative or sub-combinations. Each of these processes or blocks may be implemented in a variety of different ways. Also, although processes or blocks are at times shown as being performed in series, these processes or blocks may instead be performed or implemented in parallel, or may be performed at different times. The steps depicted in the flow diagrams and/or represented by other tables, formulas, etc. can themselves include a sequence of operations that need not be described herein. Those of ordinary skill in the art can create source code, microcode, program logic arrays and/or or computer-readable instructions to implement the depicted steps and routines based on the flowcharts and the detailed description provided herein. The routines and portions thereof can be stored in non-volatile memory that forms part of a processor contained in the kiosk 100 or otherwise associated with the kiosk 100 (e.g., a remote processor operably connected to the kiosk 100 via a wired/wireless communication link, etc.), or they can be stored in removable media, such as disks, or hardwired or preprogrammed in chips, such as EEPROM semiconductor chips.

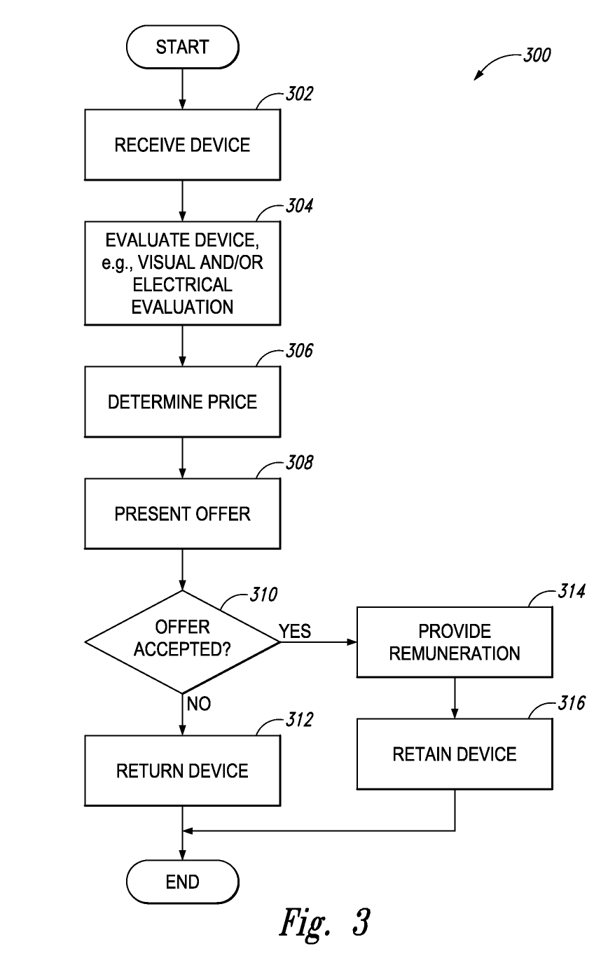

FIG. 3 is a flow diagram of a routine 300 that can be performed by the kiosk 100 for purchasing devices, e.g., mobile phones and/or other electronic devices, from users in accordance with an embodiment of the present technology. The routine can be executed by a processing device in accordance with computer-executable instructions stored on memory. In step or block 302, the routine receives the device from the user (e.g., in the inspection area 108 of the kiosk 100 (FIG. 1)). In block 304, the routine performs an evaluation, e.g., a visual and/or electrical inspection of the device, to determine various information about the device that can affect the device value. Such information can include, for example, the make, model, sub-model of the device, the device features (e.g., memory size, cell service carrier, etc.), device operability, device charge and/or rechargeability, physical condition, display function and condition, etc. After the device has been evaluated, the routine proceeds to block 306 to determine a price to offer the user for the device. In block 308, the routine presents the offer to the user (via, e.g., a textual message on the display screen 104, an audio speaker, etc.). In decision block 310, the routine determines if the user has accepted the offer price (by, e.g., providing input via a touch screen, key pad, microphone, etc. operably coupled to the kiosk 100). If the user declines the offer, the routine proceeds to block 312 and returns the device to the user. Conversely, if the user accepts the offer, the routine proceeds to block 314 and provides remuneration to the user in the amount of the purchase price. Such remuneration or payment can be in the form of, e.g., cash, a voucher redeemable for cash, merchandise, services, etc., electronic value (e.g., bitcoin, e-certificates, credit to electronic payment account, etc.), credit (e.g., a prepaid credit card, debit card, gift card, etc.), coupons, loyalty points, and/or other forms of value. In block 316, the routine retains the device (e.g., in the collection bin 234 of the kiosk 100) and the routine ends.

As discussed above, it can be important to offer the user what the user perceives as a “fair” price for the device to incentivize the user to sell the device. Moreover, it can also be important to determine a price that provides the kiosk operator (retailer, or other commercial enterprise) with a sufficient profit margin for providing the device recycling service. In some instances, however, it can be difficult to correctly identify and/or fully evaluate a mobile phone or other electronic device with a computer-controlled kiosk or similar machine for various reasons. For example, in the case of a mobile phone, the phone may not “power up” when connected to the kiosk. If the phone does not power up, then it may not be possible to electrically evaluate the phone with a suitably programmed processing device to obtain important information such as, for example, the PID, VID, carrier information, memory size, whether the phone is locked (and/or can be unlocked), LCD integrity, etc. Without a sufficient understanding of the physical and electrical aspects and/or features of a given device, it can be difficult to accurately determine a fair price for the device that is mutually beneficial to the seller (e.g., the kiosk user) and the buyer (e.g., the kiosk operator, retailer, etc.).

As noted above, many mobile phones and other electronic devices (e.g., tablets, notebooks, laptops, MP3 players, etc.) fall into or belong to groups of devices that have similar physical, visual, and/or electrical features. For example, often two or more mobile phones may have the same, or very close to the same, visual appearance (e.g., the same length, width, height/thickness, display screen shape, placement of buttons and/or connector ports, etc.). Similarly, many mobile phones and other electronic devices have equivalent or at least very similar electronic features and characteristics. For example, some mobile phone sub-models within device families (e.g., Samsung Galaxy S3 and S4 smartphones) may have the same “electrical fingerprint” or “electrical identification,” such as the same PID/VID, and/or portions of the IMEI or MEID numbers may be the same. Accordingly, one aspect of the present technology is the recognition that mobile phones and other consumer electronic devices can be arranged into similar groups, such as visually similar groups and electrically similar groups.

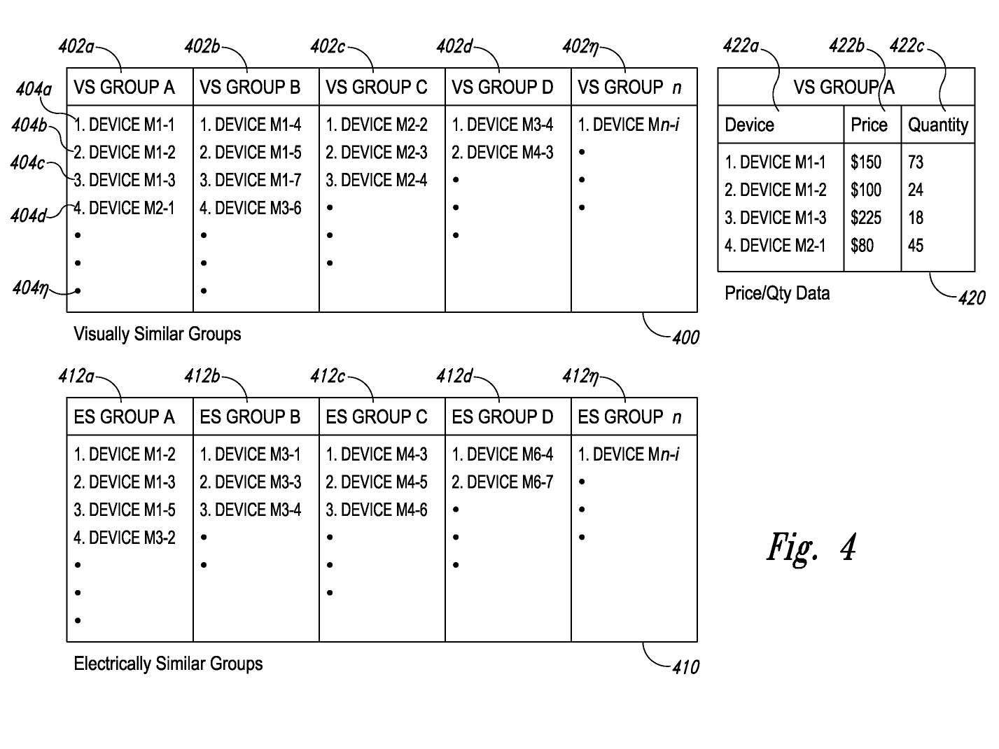

FIG. 4 illustrates a number of representative tables for mapping electronic devices to visual and/or electrical groups in accordance with the present technology. As described in greater detail below, this mapping can be used to develop group distributions (e.g., “weights”) for determining device pricing. In the illustrated embodiment, a first table 400 presents a plurality of visually similar groups A-n in a series of columns 402a-n. In this embodiment, each of the visually similar groups A-n contains a list of devices, e.g., mobile phones, in rows 404a-404n that are visually similar. For example, the mobile phones can have the same, or at least generally or approximately the same, length, width, and/or thickness. In other embodiments, the mobile phones in the visually similar groups A-n can have other visually similar features, such as the same size, shape, and/or placement of display screens, electrical connector ports, buttons, cameras, etc. Visually similar group A, for example, includes devices M1-1, M1-2, M1-3, and M2-1. For purposes of illustration, in this example, device M1-1 may represent a first device from a first manufacturer M1, device M1-2 may represent a second device from the first manufacturer M1, and so on. Additionally, in some embodiments the visually similar group A may include a device M2-1 from a second manufacturer M2. By way of example, device M1-1 may be, for example, a Samsung Galaxy S3 mobile phone with 16 GB of memory with a carrier connection from Carrier A, device M1-2 may be a Galaxy S3 mobile phone with 32 GB and Carrier B, device M1-3 may be a Galaxy S3 with 16 GB and Carrier B, and device M2-1 may be a phone from another manufacturer such as Apple, Nokia, Sony, HTC, etc., that has the same, or at least approximately the same visual features as the Galaxy S3 mobile phone. Visually similar group B includes devices M1-4, M1-5, M1-7, etc. which may, by way of example, include versions of Galaxy S4 devices having different memory sizes and/or carrier connections. As those of ordinary skill in the art will appreciate, the foregoing example and choice of device identifiers is merely representative of one way of displaying a visually similar group of mobile phones or other electronic devices in accordance with the present technology. Accordingly, in other embodiments, data representing other visually similar groups of mobile phones and/or other electronic devices can be presented in other useful formats.

Table 410 depicts one way of arranging data for electrically similar (ES) electronic devices (e.g., mobile phones) that is similar to the table 400 described above. For example, mobile phones that belong to an electrically similar group A are listed in column 412a, mobile phones that belong to an electronically similar group B are listed in column 412b, etc. By way of example, in the illustrated embodiment the electrically similar group A includes devices M1-2, M1-3, M1-5, and M3-2. In this embodiment, each of the devices listed in an electrically similar group can have a particular electronic feature or features of interest that are identical, or are at least generally similar. For example, device M1-2 and device M1-3 in group A may have the same PID/VID. Additionally or alternatively, devices in an electrically similar group can have the same cellular carrier, the same memory size, the same radio system (e.g., either CDMA (Code Division Multiple Access) or GSM (Global System for Mobiles), and/or other electronic features. Note, however, that in some instances two or more visually dissimilar devices could have the same electrical features of interest (e.g., the same PID/VID, such as a Samsung Galaxy Tablet and a Samsung Galaxy S3 mobile phone). Also note that, in other instances, two or more visually similar devices may have very different electrical features of interest, even though the devices may fall into the same visually similar group. For example, the electrically similar group A includes device M1-2 from visually similar group A and device M3-2 from visually similar group C.

In some embodiments, it can also be useful to maintain a database that associates a device price and a device quantity with each different type of device that has been, or could be, recycled by the kiosk 100 or a network of kiosks 100. Table 420, for example, provides representative price data in column 422b and representative quantity data in column 422c for each of the different electronic devices listed in the visually similar group A of the table 400. In some embodiments, the price listed in column 422b can be a preset price, such as a “device specific price,” which can be defined as the actual price paid by the kiosk 100 (or a network of kiosks 100) to purchase the device based on one or more conditions. For example, in one embodiment the device specific price can be the price paid to purchase the device in a given period of time (e.g., the past week, month, etc.). In other embodiments, the device specific price can be the price actually paid to purchase the device based on other parameters, such as the price paid in a particular location or region (e.g., a particular kiosk, state, country, etc.), the price paid during a particular time of day (e.g., morning, evening, etc.), etc. Similarly, in the illustrated embodiment the quantity listed in column 422c can be the quantity of devices that correspond to those actually purchased by the kiosk 100 (or a network of the kiosks 100) at the corresponding price listed in column 422b.

In some embodiments, the price listed in column 422b and/or the quantity listed in column 422c can be updated periodically as the prices for devices changes and/or the quantities of devices taken in by the kiosk or kiosks 100 changes. In other embodiments, the price listed in column 422b and/or the quantity listed in column 422c can be updated or revised periodically based on other factors, such as changes in the quantities of new devices being produced by certain manufacturers, changes in the quantities of new devices being purchased and put into circulation, changes in demand for certain devices on the resale market, etc. For example, in one embodiment the device price can be updated weekly based on the actual prices paid for the particular devices sold to the kiosk. In other embodiments, the price can be updated daily, monthly, and/or based on other time or other factors. To confirm that the price paid was for the correct device, the device can be inspected by a human after purchase. Similarly, in one embodiment the quantity of a particular device can also be updated periodically. For example, in one embodiment the quantity can represent the number of a particular device (which can be verified post-intake) that has been taken in by the kiosk 100 (or a network of the kiosks 100) in a previous period of time, such as the preceding week, month, day, etc.

In the foregoing manner, embodiments of the present technology enable a network of kiosks or other device intake systems to be “trained” as additional devices, successor models, etc., come to market and as their purchase prices fluctuate over time. For example, as the price/quantity data associated with devices coming into and out of the market change over time, the data in, e.g., table 420, can be updated to reflect this. Accordingly, the table 420 and various embodiments thereof can be dynamically maintained or updated to provide useful pricing and/or quantity data for mobile phones and other electronic devices in visually similar groups (as well as in electrically similar groups). Moreover, the table 420 and/or other data tables, data structures and/or other ways of collecting and maintaining data directed to mobile phones and other electronic devices can also be applied to electrically similar groups. As described in greater detail below, such data can then be used to determine pricing models, such as average or weighted average pricing models. For example, the data illustrated in FIG. 4 and/or various embodiments thereof can be used to develop prices for various electronic devices when the identity (e.g., the make, model, sub-model, electronic features, etc.) of a device taken in from a user cannot be sufficiently ascertained by the kiosk 100.

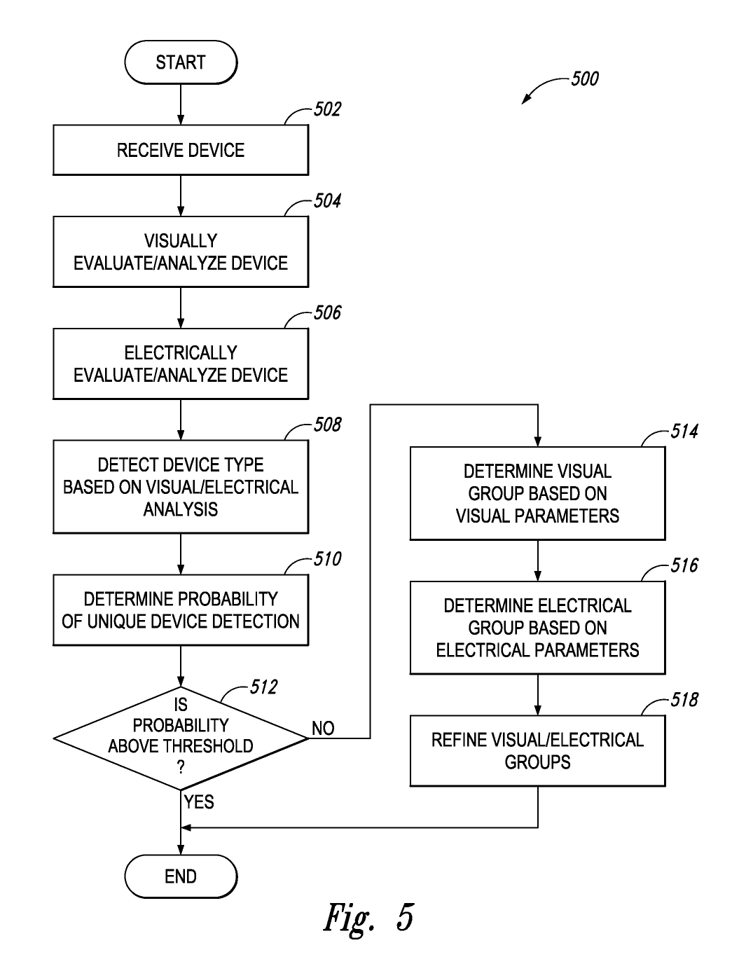

FIG. 5 illustrates a flow routine 500 for determining which visually similar and/or electrically similar group a particular electronic device belongs to or otherwise falls within in accordance with the present technology. In block 502, the routine begins by receiving the device. In some embodiments, the device can be a mobile phone received by the kiosk 100 as described in detail above. In other embodiments, the device can be other consumer electronic devices, such as a laptop computer, notebook, tablet, MP3 player, PDA, etc. In block 504, the routine visually evaluates or otherwise visually inspects the device. As described above, in some embodiments this can include utilizing one or more cameras, mirrors, etc., mounted to or otherwise associated with the upper and lower chambers 230 and 232 (FIG. 2A) to determine, for example, the length, width, and thickness dimensions of the device (e.g., “primary” visual/physical features). By way of example, in some embodiments this can include obtaining images of the device from multiple angles (e.g., top, end, side) and measuring the images to determine the external dimensions of the device. In some embodiments, these primary features can be compared (via, e.g., a template matching process) to corresponding features (e.g., length, width, thickness, etc.) of known devices stored in, e.g., a database to determine a candidate group of devices to which the subject device may belong. This information can then be used to inform further “secondary” visual inspections and/or imaging of the device to determine other visual characteristics or features, such as the existence and type of a logo (e.g., a model or brand logo), a SIM card location (as evidenced by, e.g. a hole for insertion of a SIM card eject tool), antenna location, connector ports, button locations and sizes, etc. Additionally, the device can be visually inspected/imaged to ascertain the condition and/or function of the device, such as display screen condition (e.g. cracks in the screen glass), case condition, LCD function, etc. In block 506, the routine can also electrically evaluate the device. As described above with reference to, for example, FIG. 2C, the electrical evaluation can include operably connecting a suitable electrical connector (e.g., a USB connector) to the mobile phone, and executing computer-readable instructions by the kiosk processing device to query or otherwise interrogate the mobile phone for information about device identity, features, etc. For example, in some embodiments the electrical evaluation can include determining the device PID/VID, carrier, International Mobile Station Equipment Identity (IMEI) number, Mobile Equipment Identifier (MEID) number, absence or presence of a SIM card, memory size, and/or other hardware, software, or electronic features and/or capabilities of the device.

In block 508, the routine detects the device type based on the visual/electrical analysis. By way of example, “device type” can refer to the make, model, and sub-model of the device, and device features (e.g., service carrier, memory size, whether device is locked, unlocked or unlockable, etc.). In some embodiments, for example, the kiosk 100 can utilize the visually determined parameters of the device (e.g., the length, width, thickness, screen size, button/port placement, logos, etc.) to assess and/or determine the device type by comparing these shapes and dimensions of these feature to a database or suitable lookup table of corresponding features (e.g., templates) for known devices. Similarly, in some embodiments the electrical information obtained in the electrical analysis (assuming the device can be powered up) can be used to detect the device type by comparing, for example, the PID/VID and/or IMEI/MEID to a database of known vendor and product information to determine the corresponding device vendor and product information. In some embodiments, the PID/VID can provide positive device type identification. In other instances, different device types can have the same PID/VID (e.g., a Samsung Galaxy Tablet and a Samsung Galaxy S3 mobile phone). The electrical analysis can also be used to determine carrier, memory size, locked/unlocked status, etc.

After attempting to determine the device type in block 508, the routine proceeds to block 510 and determines or generates a probability that the device detection carried out in the preceding step or steps identified a specific or unique device. By way of but one example, in some embodiments this probability can be generated by a computer-implemented comparison of the number and/or type of positively identified visual/electrical parameters to the number and/or type of unknown visual/electrical parameters. In this example, the number and/or type of known visual/electrical parameters can be used to establish a confidence or probability (e.g., a percentage) indicative of whether the device type detection accurately identified a specific or unique device type (e.g., a Galaxy S3 with 16 GB memory and Carrier A (e.g., T-Mobile)). As an example of non-unique device detection, this could occur when, for example, a device is identified as, e.g., a Galaxy S3 phone, but the memory size or carrier is unknown. In decision block 512, the routine determines if the probability is above a preset threshold. In some embodiments, the preset threshold can be established by an iterative process that can include first predicting or estimating what the threshold should be. The predicted threshold can then be implemented by the routine for a period of time, and adjusted upward if the predicted threshold results in the intake of too many devices that are incorrectly identified. Similarly, the threshold could be adjusted downward if the predicted threshold results in too many potentially desirable devices being declined. By way of example, in one embodiment a preset threshold could be set at 80%, such that the device detection based on the visual and/or electrical analysis must have a probability of at least 80% of correctly identifying a unique device. In other embodiments, other threshold levels of probability (or “confidence”) in unique device detection, both higher and lower than 80%, can be used based on other criteria as the particular situation may warrant (e.g., if post-intake human inspection of purchased devices indicates that an excessive number of devices has been incorrectly identified, it may warrant raising the probability threshold). In further embodiments, the routine can determine an accuracy of the device type detection carried out in block 508, and then determine if the accuracy is above a preset threshold. Accordingly, other methods of determining detection probability and/or confidence thresholds can be used without departing from the spirit or scope of the present disclosure.

Returning to decision block 512, if the probability (or confidence) of unique device detection is determined to be above the threshold, then the routine ends. That is, in some embodiments, if the probability that the device has been accurately detected (e.g., a specific or unique device type and/or features have been correctly detected) is above a preset threshold, then the kiosk 100 can simply offer the user the current specific device price for the device, rather than proceeding to determine an adjusted price, such as a weighted average price as described in greater detail below. Conversely, if the probability is determined to be below the threshold, then the routine proceeds to block 514 and determines which visually similar group the device belongs to based on the visual analysis of block 504. As discussed above with reference to FIG. 4, visually similar groups (e.g., the visually similar groups A, B, C, etc., of table 400) can be established by grouping together those devices that have the same or at least similar visually detectable features, such as length, width, thickness, screen placement, and size, port location, size, number, etc. Similarly, in block 516 the routine can determine which electrically similar group the electronic device belongs to based on the electrical analysis of block 506 (assuming that the device powers up). As described above with reference to FIG. 4, electrically similar groups (e.g., the electrically similar groups A, B, C, etc., of table 410) can be established by grouping together those devices that have the same or at least similar electrical features, such as PID/VID, carrier, etc.

Additionally, as shown in block 518, it is possible to refine the size of an electrically similar group corresponding to a particular device based on the visually similar group of a device. Similarly, it can also be possible to refine the size of a visually similar group corresponding to the device based on information about the electrically similar group of the device. For example, with reference to FIG. 4, if the visual analysis determined that a particular mobile phone or other electronic device was in the VS group A (column 402a), and the electrical analysis determined that the device was in the ES group A (column 412a), the combined visual/electrical group for the subject device can be narrowed down to include the device M1-2 and device M1-5, because these are the only two electronic devices that are in both VS group A and ES group A. After refining the visually/electrically similar group for the subject electronic device in block 518, the routine ends.

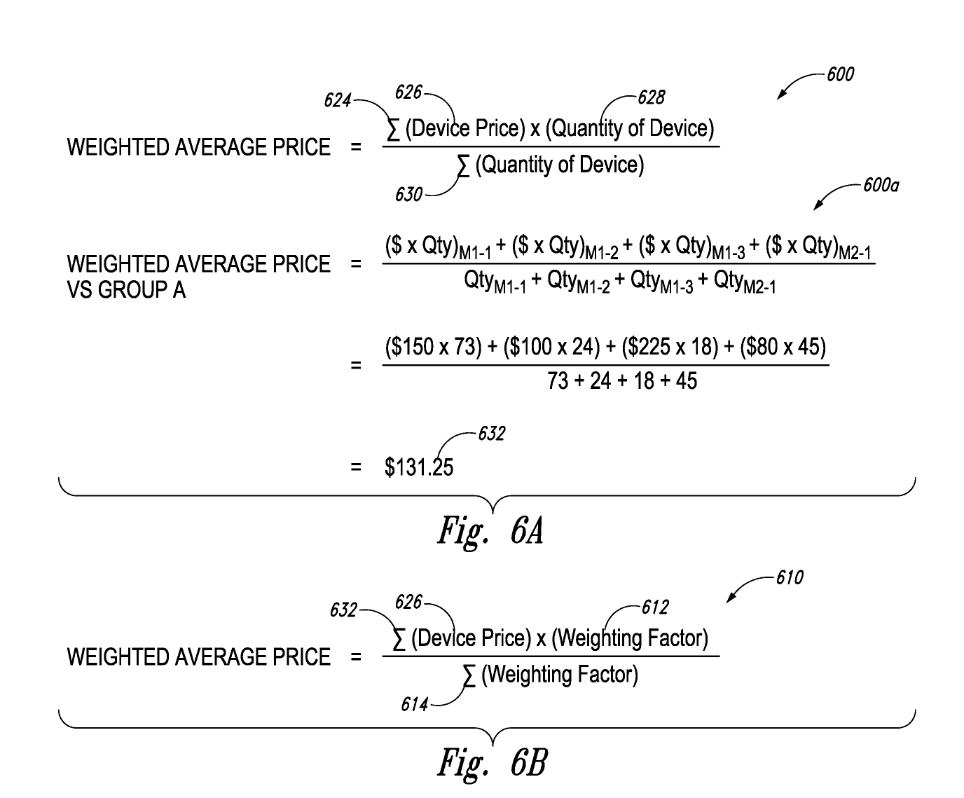

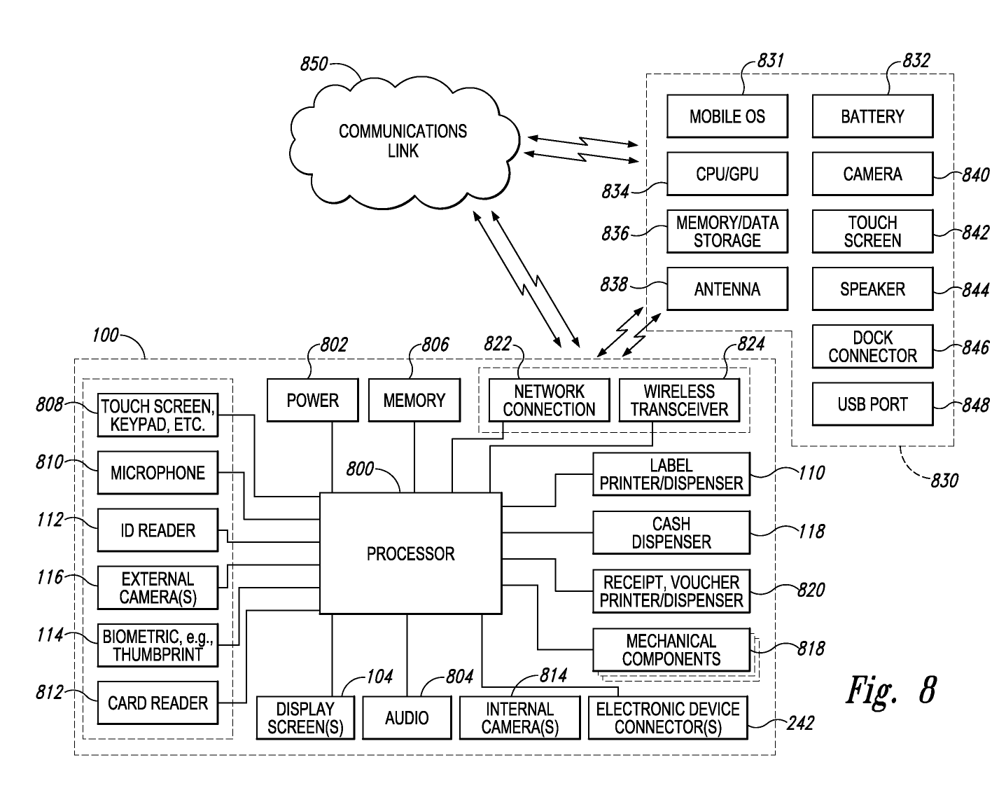

FIG. 6A illustrates a formula 600 for determining or generating an adjusted price for a mobile phone or other electronic device in accordance with an embodiment of the present technology. In the illustrated embodiment, the adjusted price is a weighted average price (“WAP”) that can be offered to the device owner to purchase the device when the kiosk 100 (or other machine for recycling or similarly processing devices) cannot detect the device type with a sufficient level of confidence. In the illustrated embodiment, all or a portion of the formula 600 can be executed by one or more processing devices associated with the kiosk 100 in accordance with computer-readable instructions stored in the memory to generate the adjusted price. As described below in reference to FIG. 8, such processing devices can include, for example, a suitable processor or central processing unit (CPU) that controls operation of the kiosk 100 in accordance with computer-readable instructions stored on system memory. In this embodiment, the WAP is calculated by first determining which group (e.g., visually similar group) the received device belongs in. In other embodiments, the WAP can be calculated by first determining which electrically similar group, or which refined visually and electrically similar group the device belongs in. Each device in the group (e.g., the visually similar group) will have a device price 626 and a device quantity 628 (e.g., the quantity of the device taken in during a previous preset period of time). As noted above, in this embodiment the device price can be the device specific price paid for the specific device in, e.g., the previous period of time, and the quantity 628 can be the corresponding number of such devices actually purchased at that price during that time. Next, for each device in the group (e.g., the first device, the second device, up through the n^{th} device in the group), the device price 626 is multiplied by the device quantity 628. After the individual prices 626 have been multiplied by their corresponding quantities 628, the results are added together to determine a summation 624 of the individual (device price)×(quantity of device) products. The summation 624 is then divided by the total number of devices in the group as determined by a summation 630 of all of the device quantities 628 in the group, to provide the weighted average price.

Formula 600a illustrates an example use of the formula 600 in accordance with an embodiment of the present technology. In this example, the formula 600 is used to determine a weighted average price for a device in the visually similar group A using the data in table 420 of FIG. 4. In the first line of formula 600a, the dollar sign “$” is used to represent the price, and “QTY” is used to indicate the quantity of the corresponding devices M1-1, M1-2, etc., in visually similar group A, as indicated by the corresponding subscripts. In the second line, the actual prices and quantity values for the devices of visually similar group A have been inserted into the formula 600a, and the last line of the formula 600a illustrates the final result, namely, that the weighted average price for a device in visually similar group A is $131.25. As those of ordinary skill in the art will appreciate, the various prices, quantities, etc. used in formula 600a are provided solely for illustrative purposes, and a wide variety of other prices, quantities, and/or other values can be used without departing form the present disclosure.

Although the embodiment of formula 600 determines weighted average price based on device price and quantity, in other embodiments other weighted prices and other weighted average prices can be determined using other factors in accordance with the present technology. For example, FIG. 6B illustrates a formula 610 that determines a weighted average price using the device price 626 (e.g., the device specific price) and a “weighting factor” 612. In this embodiment, the weighting factor 612 can be based one or more different factors, including the quantity of a device taken in during a period of time (e.g., the quantity 628); a forecasted change in quantity based on, e.g., manufacturing output, etc.; the location (such as the geographic location (mall, city, state, etc.) at which a device is submitted to one of the kiosks 100 for sale; the time of day, week, year, etc., when a device is submitted; risk tolerance (e.g., tolerance for risk of overpaying for a particular device); resale demand for a particular device; consumer characteristics or demographics (for example, likelihood of a device being a particular type can vary based on the gender, age, etc. of the seller); etc. Accordingly, in various embodiments the weighting factor 612 can be based on one of the foregoing factors, or a combination of one or more of these factors and/or other factors in accordance with the present technology. Similar to the formula 600, in this embodiment the WAP is calculated with the formula 610 by first determining which group (e.g., visually similar group) the received device belongs in. In other embodiments, the WAP can be calculated by first determining which electrically similar group, or which visually/electrically similar group the device belongs in. Next, for each device in that group, the device price 626 is multiplied by the corresponding weighting factor 612. After the individual prices 626 have been multiplied by the corresponding weighting factors 612, the results are added together to determine a summation 632, and the summation 632 is divided by the summation of all the weighting factors in the group as determined by the summation 614, to provide the weighted average price. As the foregoing illustrates, various different methods can be used to determine a weighted price, such as a weighted average price, for a particular electronic device in accordance with the present disclosure.

As discussed above, in some instances a consumer or other user may wish to sell a mobile phone or other electronic device via the kiosk 100 or other machine (e.g., an operator-assisted counter-top machine), and the kiosk 100 may not be able to sufficiently identify the device type. In these instances, the kiosk operator may be inclined to offer the user a price for the device that is too low, because of the risk that the device could in fact be the lowest-priced device in the visually similar and/or electrically similar group to which the device belongs. By way of example, if the device belonged to visually similar group A depicted by tables 400 and 420 of FIG. 4, the kiosk could offer the user $80 for the device (the lowest price in the group). In other embodiments, the kiosk 100 could offer a random price from the group. However, the user may in fact have submitted a higher-priced device to the kiosk 100 for sale, such as the device M1-1 or M1-2, which sell for $150 and $100, respectively. If the user has in fact offered to sell such a device, the user would likely decline a price offer of $80. However, if instead the user was offered the weighted average price of $131.25 as illustrated in FIG. 6A, the user would be more likely to accept the offer. Accordingly, embodiments of the present technology may enable the kiosk 100 to complete more purchase transactions and therefore recycle more mobile phones and other electronic devices in an efficient way than might otherwise be possible using other device pricing methods and systems.

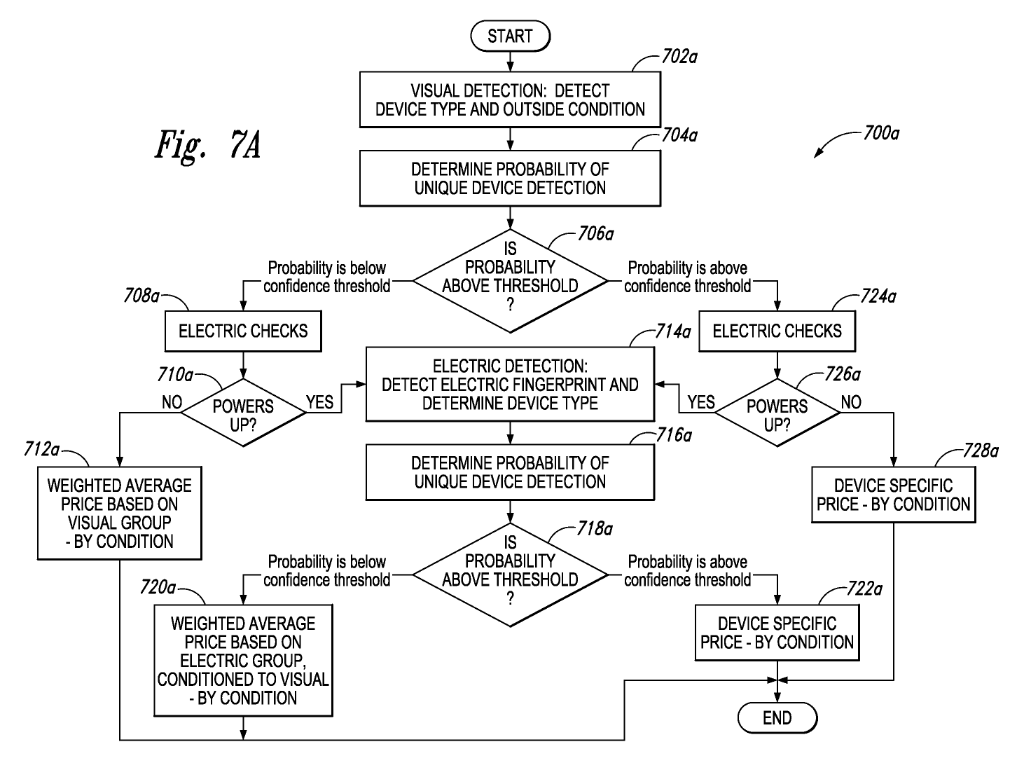

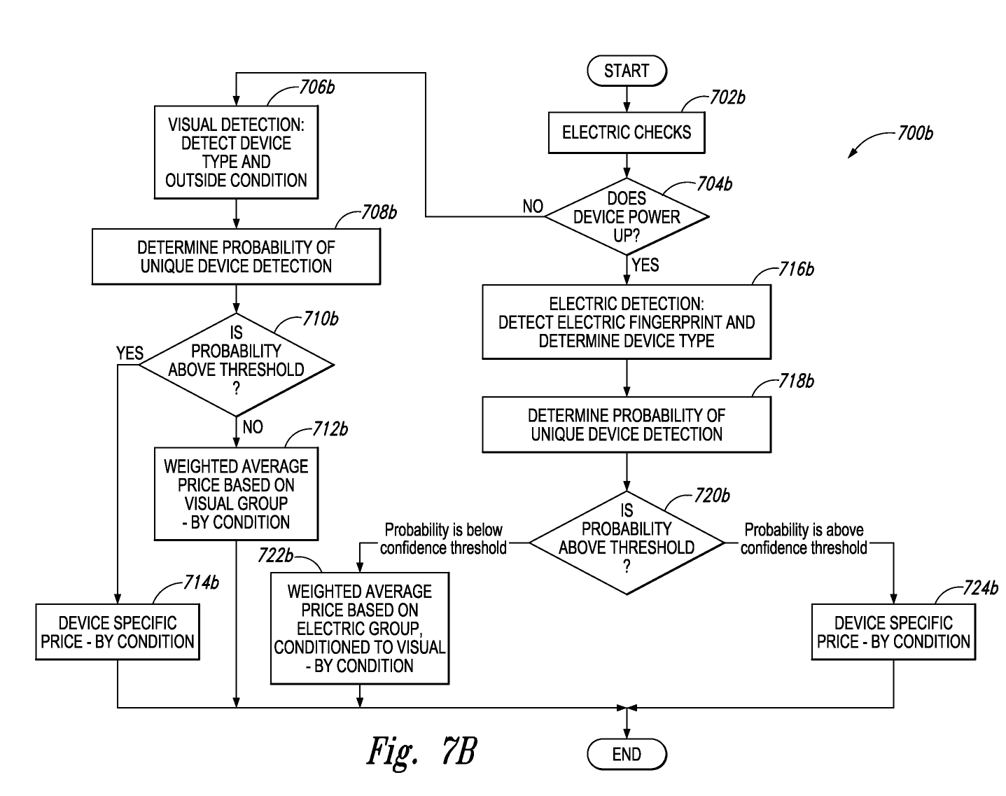

FIGS. 7A and 7B illustrate flow diagrams of routines 700a and 700b, respectively, for pricing mobile phones and/or other electronic devices in accordance with embodiments of the present technology. Various portions of the routines 700 can be performed by one or more processing devices located in or otherwise operably associated with or connected to the kiosk 100 (via, e.g., a network connection), in accordance with computer-readable instructions stored on a computer-readable medium. In other embodiments, the routines 700 and/or various portions thereof can be performed by other devices and/or in a distributed network environment. Such devices can include, for example, operator-assisted devices used by, e.g., a cashier or sales assistant at a retail establishment to facilitate the recycling, return, evaluation, and/or sale of an electronic device (e.g., a mobile phone, laptop computer, tablet, etc.) by a consumer. Additionally, it is contemplated that the routines 700, or various portions thereof, can be performed via one or more remote computer systems communicating with a mobile phone or other electronic device via a wired or wireless connection. Accordingly, although embodiments of the routines 700 described herein can be performed with the kiosk 100, other embodiments and portions thereof can be performed using other systems and methods without departing from the scope of the present disclosure.

Referring first to FIG. 7A, the routine 700a starts by receiving a mobile phone or other electronic device from a user wishing to recycle or sell the device. In block 702a, the routine performs a visual analysis of the device to determine the device's type and condition. As described above, the visual analysis can include using cameras or other imaging devices, machine vision cameras, or essentially any other suitable method to optically or visually inspect the device and determine the physical characteristics and features of the device, such as length, width, thickness, physical condition (e.g., cracks in the case, display glass, etc.), placement of features, integrity of displays (e.g., LCDs), etc. The information obtained by the visual analysis can be used to determine the device type and condition. For example, the external dimensions of the device and/or placement of various features can be compared to a database listing the corresponding features of known devices. In block 704a, the routine determines a probability that the visual analysis performed in block 702a detected a specific or unique device. By way of example, the probability can be a percentage between 0 and 100 percent (e.g., a percentage between 50% and 90%, such as 80%) and based on the number, type, and/or other aspects of the visual features that were determined (e.g., confirmed) by the visual analysis. In other embodiments, other methods for determine an acceptable probability or confidence level can be used.

In decision block 706a, the routine determines if the probability is above a preset threshold (e.g., 75%). If the probability is below the threshold (e.g., there is insufficient confidence that a unique device type was correctly identified), then the routine proceeds to block 708a to perform an electrical inspection/analysis of the device. As described above, in some embodiments the electrical analysis can include manually or automatically connecting an electrical connector (e.g., the electrical connector 242 of FIG. 2C, such as a USB connector) to the electronic device. (In other embodiments, it is contemplated that all or a portion of the electrical analysis can be performed via wireless communication between the kiosk 100 and the electronic device, or performed prior to bringing the device to the kiosk 100 via a wireless (or wired) connection between the device and a remote computer (e.g., a remote server computer, website, etc.)). In decision block 710a, the routine can initiate the electrical inspection by first determining if the device powers up via the connector. If the device does not power up, the routine proceeds to block 712a and determines an adjusted price, e.g., a weighted average price for the device based on the visually similar group to which the device belongs. As discussed above with reference to FIGS. 4 and 5, the visually similar group of the device can be determined by ascertaining physical features (e.g., dimensions) and associating the device with the visually similar group that contains devices having the same (or at least generally similar) physical features. In one embodiment, the weighted average price in block 712a can be calculated according to the formula 600 described above with reference to FIG. 6A. In another embodiment, the weighted average price in block 712a can be calculated according to the formula 610 described above with reference to FIG. 6B. Once the weighted average price for the visually similar device group has been determined, this price can also be adjusted by device condition. For example, if the device has, e.g., broken glass on the display or cracks in the case, the price can be adjusted downward from the weighted average price. Similarly, if the device appears to be in very good condition, then the full weighted average price can be used. After the user has been offered the price determined in block 712a for the device, the routine ends.

Returning to decision block 710a, if the device does power up, the routine proceeds to block 714a and performs an electric detection or analysis. In some embodiments, the electrical analysis in block 714a can include transmitting instructions, prompts, and/or other digital instructions to the electronic device via the connector that causes the device to provide various identification information (e.g., an “electric fingerprint”), such as the device PID/VID, carrier, absence or presence of a SIM card, memory capacity, and other electrical features and characteristics. The device type is then determined based on the electric analysis, and the routine proceeds to block 716a. In block 716a, the routine determines a probability that the device detection based on the electric analysis detected a specific or unique device. As discussed above with reference to block 704a, the probability can be a percentage between 0 and 100 (e.g., 75%, 80%, etc.) that corresponds to a level of confidence that a unique device type has been correctly identified. In decision block 718a, the routine determines if the probability from block 716a is above a preset threshold. If the probability is below the threshold, the routine proceeds to block 720a and determines the weighted average price of the device based on the electrically similar group to which the device belongs. In some embodiments, the weighted average price can be determined in block 720a based on the electrically similar group conditioned (e.g., refined) by the visually similar group and/or adjusted based on the condition of the device (as determined by, e.g., the visual analysis). As discussed above with reference to FIG. 4, conditioning the electrically similar group based on the visual analysis can include narrowing or refining the size of the electrically similar group by removing those devices that do not also fall within the visually similar group corresponding to the device. Once the weighted average price has been calculated in this manner, the weighted average price can be further conditioned based on the physical condition or the electrical condition of the device. After the weighted average price, as adjusted, has been determined, the price can be offered to the user and the routine ends.

Returning to decision block 718a, if the probability of accurate device detection based on the electrical analysis is above the threshold, the routine proceeds to block 722a and offers the user the device-specific price for the device, adjusted based on the physical and/or electrical condition of the device. Here, the device-specific price can correspond to the actual price that has been paid in, e.g., a previous period of time, to purchase the same device type from other users via, e.g., the kiosk 100 or a network of kiosks 100. After block 722a, the routine ends.

Returning to decision block 706a, if the probability of unique device type detection based on the visual analysis was above the threshold, the routine proceeds to block 724a and performs an electrical analysis of the device as described above. As above, the electrical analysis can begin in decision block 726a by first determining whether the device powers up, as further electrical analysis of the device cannot be performed if the device is not operative. If the device does power up, the routine performs the electrical analysis in block 714a and proceeds from there as described above. Conversely, if the device will not power up, the routine proceeds to block 728a and offers the user the device-specific price, adjusted by the physical and/or electrical condition of the device. After block 728a, the routine ends.

Referring next to FIG. 7B, the routine 700b starts by receiving an electronic device (e.g., a mobile phone) from a user wishing to recycle or sell the device. In block 702b, the routine performs an electrical inspection/analysis of the device. As described above, in some embodiments the electrical analysis can include manually or automatically connecting an electrical connector to the electronic device. In decision block 704b, the routine can initiate the electrical inspection by first determining if the device powers up via the connector. If the device does not power up, the routine proceeds to block 706b and performs a visual analysis of the device to determine the device type and condition. As described above, the visual analysis can include using cameras or other imaging devices to visually inspect the device and determine the physical characteristics and features of the device, such as length, width, thickness, physical condition (e.g., cracks in the case, display glass, etc.), placement of features, etc. The routine uses the information obtained by the visual analysis to determine the device type and condition.

In block 708b, the routine determines a probability that the device type as detected by the visual analysis in block 706b detected a unique device. In decision block 710b, the routine determines if the probability is above a preset threshold (e.g., 75%). If the probability is below the threshold (e.g., there is insufficient confidence that a unique device type has been correctly identified), then the routine proceeds to block 712b and determines a weighted average price for the device based on the visually similar group to which the device belongs. Once the weighted average price for the visually similar device group has been determined, this price can be adjusted based on device condition. The user can then be offered the weighted average price for the device, and the routine ends. Returning to decision block 710b, if the probability is above the threshold, then the routine proceeds to block 714b and determines the device specific price for the device (by referral to e.g., a database of device specific prices), which can also be adjusted based on device condition. After block 714b, the routine ends.

Returning to decision block 704b, if the device does power up, the routine proceeds to block 716b and performs an electric detection or analysis. As described above, the electrical analysis can include obtaining various information about the device, such as the device PID/VID, carrier, absence or presence of a SIM card, memory capacity, and other electrical features and characteristics. The device type is then determined based on the electric analysis, and the routine proceeds to block 718b to determine a probability that the device detection based on the electric analysis detected a unique device. As discussed above, the probability can be a percentage between 0 and 100 (e.g., 75%, 80%, etc.) that corresponds to a level of confidence a unique device type has been correctly identified. In decision block 720b, the routine determines if the probability from block 718b is above a preset threshold. If the probability is below the threshold, the routine proceeds to block 722b and determines the weighted average price of the device based on the electrically similar group to which the device belongs. In some embodiments, the routine can also perform a visual inspection (e.g., the visual inspection of block 706b) and narrow or refine the size of the electrically similar group by removing those devices that do not also fall within the visually similar group corresponding to the device. In this embodiment, the routine can then determine a weighted average price based on the narrowed electrical group and adjust the price based on the condition of the device (as determined by, e.g., the visual analysis). After the weighted average price, as adjusted, has been determined in block 722b, the price can be offered to the user and the routine ends. Returning to decision block 720b, if the probability of accurate device detection based on the electrical analysis is above the threshold, the routine proceeds to block 724b and offers the user the device-specific price for the device, adjusted based on the physical and/or electrical condition of the device. After block 724b, the routine ends.

The flow diagrams described herein (e.g., those described with reference to FIGS. 3, 5, 7A and 7B) are representative flow diagrams that depict routines and processes used in some embodiments. These processes and routines can be executed by a processing device, such as a processor or CPU associated with the kiosk 100 (as described below with reference to, e.g., FIG. 8), an associated server computer, wireless device, personal computer, etc. in accordance with computer-executable instructions stored on a computer-readable medium. Those skilled in the relevant art will appreciate that aspects of the invention can be practiced with other communications, data processing, or computer system configurations, including: Internet appliances, hand-held devices (including personal digital assistants (PDAs)), wearable computers, all manner of cellular or mobile phones (including Voice over IP (VoIP) phones), dumb terminals, media players, gaming devices, multi-processor systems, microprocessor-based or programmable consumer electronics, set-top boxes, network PCs, mini-computers, mainframe computers, and the like. Indeed, the terms “computer,” “server,” “host,” “host system,” and the like, are generally used interchangeably herein and refer to any of the above devices and systems, as well as any data processor. These flow diagrams may not show all functions or exchanges of data, but instead they provide an understanding of commands and data exchanged under the system. Those skilled in the relevant art will recognize that some functions or exchange of commands and data may be repeated, varied, omitted, or supplemented, and other (less important) aspects not shown may be readily implemented. For example, while processes or blocks are presented in a given order, alternative implementations may perform routines having steps, or employ systems having blocks in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel, or may be performed at different times. Various steps depicted in the flow diagrams can be of a type well known in the art and can itself include a sequence of operations that need not be described herein. Those of ordinary skill in the art can create source code, microcode, program logic arrays or otherwise implement the inventions described herein based on the Figures and the detailed description provided herein. The routines described above can be stored in non-volatile memory, or in removable media, such as disks, or hardwired or preprogrammed in chips, such as EEPROM semiconductor chips.

FIG. 8 provides a schematic representation of an architecture of the kiosk 100 in accordance with an embodiment of the present technology. In the illustrated embodiment, the kiosk 100 includes a suitable processor or central processing unit (“CPU”) 800 that controls operation of the kiosk 100 in accordance with computer-readable instructions stored on system memory 806. The CPU 800, for example, can control performance of the various pricing routines and/or generation of the weighted average prices described herein with reference to, for example, FIGS. 3-7B. The CPU 800 may be any logic processing unit, such as one or more CPUs, digital signal processors (DSPs), application-specific integrated circuits (ASICs), etc. The CPU 800 may be a single processing unit or multiple processing units in a device or distributed across multiple devices. The CPU 800 is connected to the memory 806 and may be coupled to other hardware devices, for example, with the use of a bus (e.g., a PCI Express or Serial ATA bus). The CPU 800 can include, by way of example, a standard personal computer (“PC”) (e.g., a DELL OPTIPLEX 780 or 7010 PC) or other type of embedded computer running any suitable operating system, such as Linux, Windows, Android, iOS, MAC OS, or an embedded real-time operating system. In some embodiments, the CPU 800 can be a small form factor PC with integrated hard disk drive (“HDD”) or solid-state drive (“SSD”) and universal serial bus (“USB”) or other ports to communicate with the other components of the kiosk 100. In other embodiments, the CPU 800 can include a microprocessor with a standalone motherboard that interfaces with a separate HDD. The memory 806 can include read-only memory (ROM) and random access memory (RAM) or other storage devices, such as disk drives or SSDs, that store the executable applications, test software, databases and other software required to, for example, implement the various routines described herein (e.g., those described with reference to FIGS. 3, 5, 7A and 7B), control kiosk components, process electronic device information and data (to, e.g., evaluate device make, model, condition, pricing, etc.), communicate and exchange data and information with remote computers and other devices, etc.

The CPU 800 can provide information and instructions to kiosk users via the display screen 104 and/or an audio system (e.g., a speaker) 804. The CPU 800 can also receive user inputs via, e.g., a touch screen 808 associated with the display screen 104, a keypad with physical keys, and/or a microphone 810. Additionally, the CPU 800 can receive personal identification and/or biometric information associated with users via the ID reader 112, one or more of the external cameras 116, and/or the fingerprint reader 114. In some embodiments, the CPU 800 can also receive information (such as user identification and/or account information) via a card reader 812 (e.g., a debit, credit, or loyalty card reader having, e.g., a suitable magnetic stripe reader, optical reader, etc.). The CPU 800 can also control operation of the label dispenser 110 and systems for providing remuneration to users, such as the cash dispenser 118 and/or a receipt or voucher printer and an associated dispenser 820.

As noted above, the kiosk 100 additionally includes a number of electronic, optical and electromechanical devices for electrically, visually and/or physically analyzing electronic devices placed therein for recycling. Such systems can include one more internal cameras 814 for visually inspecting electronic devices to, e.g., determine the external dimensions and condition, and one or more of the electrical connectors 242 (e.g., USB connectors) for, e.g., powering up electronic devices and performing electronic analyses. As noted above, the cameras 814 can be operably coupled to the upper and lower chambers 230 and 232, and the connectors 242 can be movably and interchangeably carried by the carrousel 240 (FIGS. 2A-2D). The kiosk 100 further includes a plurality of mechanical components that are electronically actuated for carrying out the various functions of the kiosk 100 during operation. The mechanical components 818 can include, for example, the inspection area access door 106 and one or more of the movable components (e.g. the inspection plate 244, the upper and lower chambers 230 and 232, etc.) operably disposed within the inspection area 108 (FIG. 1). The kiosk 100 further includes power 802, which can include battery power and/or facility power for operation of the various electrical components associated with kiosk operation.

In the illustrated embodiment, the kiosk 100 further includes a network connection 822 (e.g., a wired connection, such as an Ethernet port, cable modem, FireWire cable, Lightning connector, USB port, etc.) suitable for communication with, e.g., all manner of remote processing devices via a communication link 850, and a wireless transceiver 824 (e.g., including a Wi-Fi access point, Bluetooth transceiver, near-field communication (NFC) device, and/or wireless modem or cellular radio utilizing GSM, CDMA, 3G and/or 4G technologies) for data communications suitable for communication with, e.g., all manner of remote processing devices via the communication link 850 and/or directly via, e.g., a wireless peer-to-peer connection. For example, the wireless transceiver 824 can facilitate wireless communication with handheld devices, such as a mobile device 830 (e.g., a smartphone) either in the proximity of the kiosk 100 or remote therefrom. By way of example only, in the illustrated embodiment the mobile device 830 can include one or more features, applications and/or other elements commonly found in smartphones and other known mobile devices. For example, the mobile device 830 can include a CPU and/or a graphics processing unit (“GPU”) 834 for executing computer readable instructions stored on memory 836. In addition, the mobile device 830 can include an internal power source or battery 832, a dock connector 846, a USB port 348, a camera 840, and/or well-known input devices, including, for example, a touch screen 842, a keypad, etc. In many embodiments, the mobile device 830 can also include a speaker 844 for two-way communication and audio playback. In addition to the foregoing features, the mobile device 830 can include a mobile operating system (OS) 831 and/or a device wireless transceiver that may include one or more antennas 338 for wirelessly communicating with, for example, other mobile devices, websites, and the kiosk 100. Such communication can be performed via, e.g., the communication link 850 (which can include the Internet, public and private intranet, a local or extended Wi-Fi network, cell towers, the plain old telephone system (POTS), etc.), direct wireless communication, etc.

Unless described otherwise, the construction and operation of the various components shown in FIG. 8 are of conventional design. As a result, such components need not be described in further detail herein, as they will be readily understood by those skilled in the relevant art. In other embodiments, the kiosk 100 and/or the mobile device 830 can include other features that may be different from those described above. In still further embodiments, the kiosk 100 and/or the mobile device 830 can include more or fewer features similar to those described above.

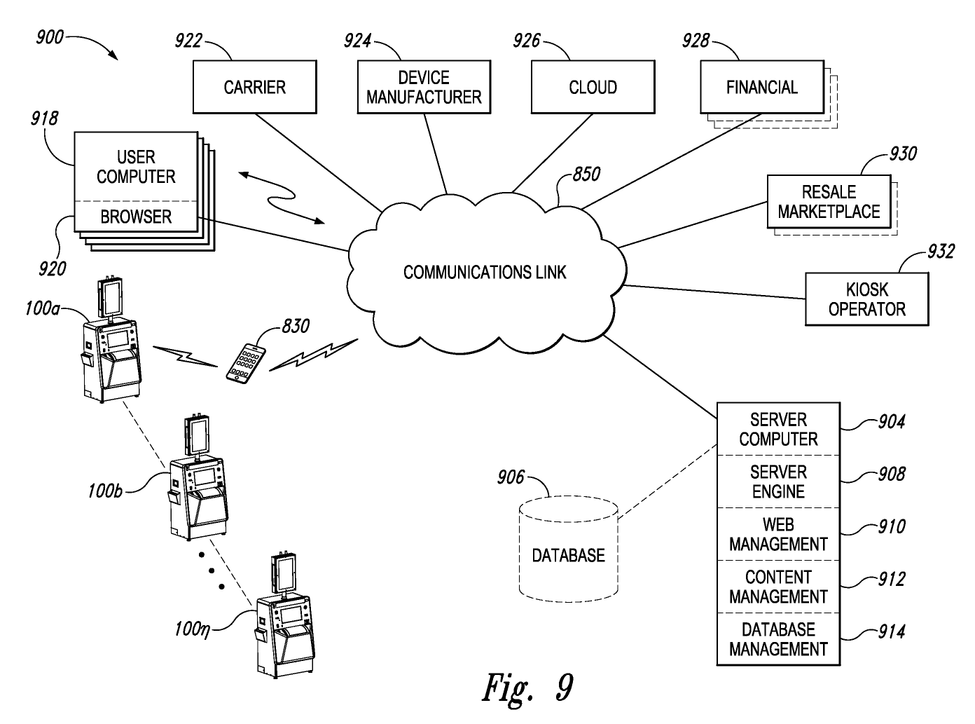

FIG. 9 is a schematic diagram of a suitable network environment for implementing various aspects of an electronic device recycling system 900 configured in accordance with embodiments of the present technology. In the illustrated embodiment, a plurality of the kiosks 100 (identified individually as kiosks 100a-100n) can exchange information with one or more remote computers (e.g., one or more server computers 904) via the communication link 850. Although the communication link 850 can include a publically available network (e.g., the Internet with a web interface), a private communication link, such as an intranet or other network may also be used. Moreover, in various embodiments the individual kiosk 100 can be connected to a host computer (not shown) that facilitates the exchange of information between the kiosks 100 and remote computers, other kiosks, mobile devices, etc.

The server computer 904 can perform many or all of the functions for receiving, routing and storing electronic messages, such as webpages, audio signals and electronic images necessary to implement the various electronic transactions described herein. For example, the server computer 904 can retrieve and exchange web pages and other content with an associated database or databases 906. In some embodiments, the database 906 can include information related to mobile phones and/or other consumer electronic devices. Such information can include, for example, make, model, serial number, IMEI, MEID, carrier plan information, pricing information, owner information, etc., as well as dimensional information (size, shape, location of displays, ports, etc.) and other visual information (e.g., logo shapes, sizes, locations, etc.) associated with known devices, such as particular device models, sub-models, etc. In various embodiments the server computer 904 can also include a server engine 908, a web page management component 910, a content management component 912, and a database management component 914. The server engine 908 can perform the basic processing and operating system level tasks associated with the various technologies described herein. The webpage management component 910 can handle creation and/or display and/or routing of web or other display pages. The content management component 912 can handle many of the functions associated with the routines described herein. The database management component 914 can perform various storage, retrieval and query tasks associated with the database 906, and can store various information and data such as animation, graphics, visual and audio signals, etc. Those of ordinary skill in the art will appreciate that many of the routines and/or portions thereof and other functions and methods described above can be performed by the kiosk 100 (e.g., the processor 800), the server computer 904, or both.

In the illustrated embodiment, the kiosks 100 can also be operably connected to a plurality of other remote devices and systems via the communication link 850. For example, the kiosks 100 can be operably connected to a plurality of user devices 918 (e.g., personal computers, laptops, handheld devices, etc.) having associated browsers 920. Similarly, as described above the kiosks 100 can each include wireless communication facilities for exchanging digital information with mobile devices, such as the mobile device 830. The kiosks 100 and/or the server computer 904 are also operably connectable to a series of remote computers for obtaining data and/or exchanging information with necessary service providers, financial institutions, device manufactures, authorities, government agencies, etc. For example, the kiosks 100 and the server computer 904 can be operably connected to one or more cell carriers 922, one or more device manufacturers 924 (e.g., mobile phone manufacturers), one or more electronic payment or financial institutions 928, one or more databases (e.g., the GSMA International Mobile Equipment Identity Database, etc.), and one or more computers and/or other remotely located or shared resources associated with cloud computing 926. The financial institutions 928 can include all manner of entity associated with conducting financial transactions, including banks, credit/debit card facilities, online commerce facilities, online payment systems, virtual cash systems, money transfer systems, etc.

In addition to the foregoing, the kiosks 100 and the server computer 904 can also be operably connected to a resale marketplace 930 and a kiosk operator 932. The resale marketplace 930 represents a system of remote computers and/or services providers associated with the reselling of consumer electronic devices through both electronic and brick-and-mortar channels. Such entities and facilities can be associated with, for example, online auctions for reselling used electronic devices as well as for establishing market prices for such devices. The kiosk operator 932 can be a central computer or system of computers for controlling all manner of operation of the network of kiosks 100. Such operations can include, for example, remote monitoring and facilitating of kiosk maintenance (e.g., remote testing of kiosk functionality, downloading operational software and updates, etc.), servicing (e.g., periodic replenishing of cash and other consumables), performance, etc. In addition, the kiosk operator 932 can further include one or more display screens operably connected to cameras located at each of the kiosks 100 (e.g., one or more of the cameras 116 described above with reference to FIG. 1). This remote viewing capability enables operator personnel to verify user identification and/or make other visual observations at the kiosks 100 in real-time during transactions, as described above with reference to FIG. 1.

The foregoing description of the electronic device recycling system 900 illustrates but one possible network system suitable for implementing the various technologies described herein. Accordingly, those of ordinary skill in the art will appreciate that other systems consistent with the present technology can omit one or more of the facilities described in reference to FIG. 9 or may include one or more additional facilities not described in detail in FIG. 9.

Those of ordinary skill in the art will appreciate that the routines and other functions and methods described above can be performed by various processing devices, such as the kiosk processor 800 (FIG. 8), the server computer 904 (FIG. 9), or both. The processes can be implemented as an application specific integrated circuit (ASIC), by a digital signal processing (DSP) integrated circuit, through conventional programmed logic arrays or circuit elements. While many of the embodiments are shown and described as being implemented in hardware (e.g., one or more integrated circuits designed specifically for a task), such embodiments could equally be implemented in software and be performed by one or more processors. Such software can be stored on any suitable computer-readable medium, such as microcode stored in a semiconductor chip, on a computer-readable disk, or downloaded from a server and stored locally at a client.

The kiosks 100, mobile devices 330, server computers 904, user computers and/or other user devices 918, etc. may include one or more central processing units or other logic-processing circuitry, memory, input devices (e.g., keyboards and pointing devices), output devices (e.g., display devices and printers), and storage devices (e.g., magnetic, solid state, fixed and floppy disk drives, optical disk drives, etc.). Such computer devices may include other program modules such as an operating system, one or more application programs (e.g., word processing or spread sheet applications), and the like. The user computers may include wireless computers, such as mobile phones, personal digital assistants (PDAs), palm-top computers, etc., which communicate with the Internet via a wireless link. The computers may be general-purpose devices that can be programmed to run various types of applications, or they may be single-purpose devices optimized or limited to a particular function or class of functions. Aspects of the invention may be practiced in a variety of other computing environments.

While the Internet is shown, a private network, such as an intranet may likewise be used herein. The network may have a client-server architecture, in which a computer is dedicated to serving other client computers, or it may have other architectures such as peer-to-peer, in which one or more computers serve simultaneously as servers and clients. A database or databases, coupled to the server computer(s), stores much of the web pages and content exchanged between the user computers. The server computer(s), including the database(s), may employ security measures to inhibit malicious attacks on the system and preserve the integrity of the messages and data stored therein (e.g., firewall systems, message encryption and/or authentication (e.g., using transport layer security (TLS) or secure socket layers (SSL)), password protection schemes, encryption of stored data (e.g., using trusted computing hardware), and the like).

One skilled in the relevant art will appreciate that the concepts of the invention can be used in various environments other than location based or the Internet. In general, a display description may be in HTML, XML or WAP format, email format or any other format suitable for displaying information (including character/code-based formats, algorithm-based formats (e.g., vector generated), and bitmapped formats). Also, various communication channels, such as local area networks, wide area networks, or point-to-point dial-up connections, may be used instead of the Internet. The system may be conducted within a single computer environment, rather than a client/server environment. Also, the user computers may comprise any combination of hardware or software that interacts with the server computer, such as television-based systems and various other consumer products through which commercial or noncommercial transactions can be conducted. The various aspects of the invention described herein can be implemented in or for any e-mail environment.

Although not required, aspects of the invention are described in the general context of computer-executable instructions, such as routines executed by a general-purpose data processing device, e.g., a server computer, wireless device or personal computer. Those skilled in the relevant art will appreciate that aspects of the invention can be practiced with other communications, data processing, or computer system configurations, including Internet appliances, hand-held devices (including personal digital assistants (PDAs)), wearable computers, all manner of cellular or mobile phones (including Voice over IP (VoIP) phones), dumb terminals, media players, gaming devices, multi-processor systems, microprocessor-based or programmable consumer electronics, set-top boxes, network PCs, mini-computers, mainframe computers, and the like. Indeed, the terms “computer,” “server,” “host,” “host system,” and the like, are generally used interchangeably herein, and refer to any of the above devices and systems, as well as any data processor. Input devices may include a touchpad, keyboard and/or a pointing device such as a mouse. Other input devices are possible such as a microphone, joystick, pen, game pad, scanner, digital camera, video camera, and the like. The data storage devices may include any type of computer-readable media that can store data accessible by a computer, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to a network such as a local area network (LAN), wide area network (WAN) or the Internet.

Aspects of the invention can be embodied in a special purpose computer or data processor that is specifically programmed, configured, or constructed to perform one or more of the computer-executable instructions explained in detail herein. While aspects of the invention, such as certain functions, are described as being performed exclusively on a single device, the invention can also be practiced in distributed environments where functions or modules are shared among disparate processing devices, which are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. The data storage devices may include any type of computer-readable media that can store data accessible by a computer, such as magnetic hard and floppy disk drives, optical disk drives, magnetic cassettes, tape drives, flash memory cards, DVDs, Bernoulli cartridges, RAM, ROMs, smart cards, etc. Indeed, any medium for storing or transmitting computer-readable instructions and data may be employed, including a connection port to a network such as a LAN, WAN, or the Internet. Alternatively, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). The terms “memory” and “computer-readable storage medium” include any combination of temporary, persistent, and/or permanent storage, e.g., ROM, writable memory such as RAM, writable non-volatile memory such as flash memory, hard drives, solid state drives, removable media, and so forth, but do not include a propagating signal per se.

The above Detailed Description of examples and embodiments of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. References throughout the foregoing description to features, advantages, or similar language do not imply that all of the features and advantages that may be realized with the present technology should be or are in any single embodiment of the invention. Rather, language referring to the features and advantages is understood to mean that a specific feature, advantage, or characteristic described in connection with an embodiment is included in at least one embodiment of the present technology. Thus, discussion of the features and advantages, and similar language, throughout this specification may, but do not necessarily, refer to the same embodiment. Furthermore, the described features, advantages, and characteristics of the present technology may be combined in any suitable manner in one or more embodiments. One skilled in the relevant art will recognize that the present technology can be practiced without one or more of the specific features or advantages of a particular embodiment. In other instances, additional features and advantages may be recognized in certain embodiments that may not be present in all embodiments of the present technology.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

Unless the context clearly requires otherwise, throughout the description and the claims, the words “comprise,” “comprising,” and the like, are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements. Further any specific numbers noted herein are only examples—alternative implementations may employ differing values or ranges.

While the above description describes various embodiments of the invention and the best mode contemplated, regardless how detailed the above text, the invention can be practiced in many ways. Details of the system may vary considerably in its specific implementation, while still being encompassed by the present disclosure. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims. Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

I/we claim:

1. A method performed by a computing device for recycling electronic devices, the method comprising:
receiving an electronic device from a user at a kiosk, wherein the device is of a type that has associated therewith a preset price;
evaluating the device with the kiosk to identify the device type;
when the kiosk has sufficiently identified the device type, automatically offering the user the preset price for the device; and
when the kiosk has insufficiently identified the device type, automatically offering the user an average price, different from the preset price, for the device.

2. The method of claim 1 wherein the average price is a weighted average price.

3. The method of claim 1, further comprising generating a weighted average price for the device, wherein the average price is the weighted average price.

4. The method of claim 1, further comprising:
determining a group that the electronic device belongs to, wherein the group includes a plurality of different electronic devices having similar features; and
generating the average price based on the group.

5. The method of claim 1, further comprising:
determining a visual group that the electronic device belongs to, wherein the visual group includes a plurality of different electronic devices having visually similar features; and
generating the average price based on the visual group.

6. The method of claim 1, further comprising:
determining an electrical group that the electronic device belongs to, wherein the electrical group includes a plurality of different electronic devices having electrically similar features; and
generating the average price based on the electrical group.

7. The method of claim 1, wherein evaluating the electronic device with the kiosk includes evaluating the device based at least partially on a visual analysis of at least a portion of the device, and wherein the method further comprises determining a probability that the evaluation based on the visual analysis identified a unique device type, wherein offering the user an average price for the electronic device includes offering the user the average price when the probability is below a threshold.

8. The method of claim 1, wherein evaluating the electronic device with the kiosk includes evaluating the device based at least partially on an electrical analysis of the device, and wherein the method further comprises determining a probability that the evaluation based on the electrical analysis identified a unique device type, wherein offering the user an average price for the electronic device includes offering the user the average price when the probability is below a threshold.

9. The method of claim 1 wherein the device is a particular model manufactured by a particular maker, wherein evaluating the device with the kiosk includes attempting to identify at least one of the model or maker with the kiosk, and wherein offering the user an average price for the electronic device includes offering the user the average price when the kiosk is unable to identify at least one of the model or maker.

10. The method of claim 1 wherein the device is a particular model of mobile phone manufactured by a particular maker, wherein evaluating the device with the kiosk includes attempting to identify at least one of the model or maker with the kiosk, and wherein offering the user an average price for the electronic device includes offering the user the average price when the kiosk is unable to identify at least one of the model or maker.

11. The method of claim 1 wherein receiving an electronic device from a user includes receiving a laptop computer, and wherein evaluating the device with the kiosk includes evaluating the laptop computer.

12. A method performed by a computing device for purchasing electronic devices with a user operated kiosk, the method comprising:
receiving an electronic device from a user at the kiosk;
inspecting the electronic device with the kiosk;
based on the inspection, determining a group that the electronic device belongs to, wherein the group includes a plurality of different electronic devices having similar features;
determining an adjusted price based on the group; and
offering the user the adjusted price for the electronic device.

13. The method of claim 12:
wherein the group of similar electronic devices is comprised of at least a first quantity of a first type of electronic device and a second quantity of a second type of electronic device, and
wherein determining an adjusted price includes generating a weighted price based at least in part on the first and second quantities.

14. The method of claim 12:
wherein the group of similar electronic devices is comprised of at least a first quantity of a first type of electronic device and a second quantity of a second type of electronic device,
wherein the first type of electronic device has a first price and the second type of electronic device has a second price, and
wherein determining the adjusted price includes generating a weighted price based at least in part on the first and second quantities and the first and second prices.

15. The method of claim 12:
wherein the group of similar electronic devices is comprised of at least a first quantity of a first type of electronic device and a second quantity of a second type of electronic device,
wherein the first type of electronic device has a first price and the second type of electronic device has a second price, and
wherein determining the adjusted price includes determining a weighted average price according to the following formula:
$$WAP = \frac{\sum {( \$ \times Qty )}_{D 1} + {( \$ \times Qty )}_{D 2} + … {( \$ \times Qty )}_{Dn}}{\sum {Qty}_{D 1} + {Qty}_{D 2} + … {Qty}_{D n}}$$
where $_{D1} is the first price, $_{D2} is the second price, $_{Dn} is a price of an n^{th} electronic device in the group, Qty_{D1} is the first quantity, Qty_{D2} is the second quantity, and Qty_{Dn} is a quantity of the n^{th} electronic device in the group.

16. The method of claim 12 wherein the kiosk is one of a plurality of electronic device recycling kiosks, and wherein the method further comprises:
receiving a first quantity of a first type of electronic device via the plurality of electronic device recycling kiosks;
receiving a second quantity of a second type of electronic device via the plurality of electronic device recycling kiosks; and
determining the adjusted price based at least in part on the first and second quantities.

17. The method of claim 12 wherein the kiosk is one of a plurality of electronic device recycling kiosks, and wherein the method further comprises:
receiving a first quantity of a first type of electronic device via the plurality of electronic device recycling kiosks in a preset period of time;
receiving a second quantity of a second type of electronic device via the plurality of electronic device recycling kiosks in the preset period of time; and
determining the adjusted price based at least in part on the first and second quantities.

18. The method of claim 12 wherein the kiosk is one of a plurality of electronic device recycling kiosks, and wherein the method further comprises:
receiving a first quantity of a first type of electronic device via the plurality of electronic device recycling kiosks;
paying a first price to individually purchase each of the first type of electronic device in the first quantity;
receiving a second quantity of a second type of electronic device via the plurality of electronic device recycling kiosks; and
paying a second price to individually purchase each of the second type of electronic device in the second quantity, wherein determining the adjusted price includes determining a weighted average price based at least in part on the first and second quantities and the first and second prices.

19. A method performed by a computing device for purchasing used electronic devices, the method comprising:
receiving an electronic device at a user-operated kiosk, the kiosk including at least one imaging component;
obtaining visual information about the electronic device by use of the imaging component;
at least partially identifying the electronic device based at least in part on the visual information;
determining an accuracy of the at least partial identification of the electronic device;
when the accuracy of the at least partial identification is above a preselected threshold, offering to purchase the electronic device for a device-specific price; and
when the accuracy of the at least partial identification is below the preselected threshold, offering to purchase the electronic device for a weighted average price.

20. The method of claim 19 wherein the kiosk further includes at least one electrical connector, and wherein the method further comprises:
obtaining electrical information about the electronic device by use of the electrical connector, wherein at least partially identifying the electronic device includes at least partially identifying the electronic device based at least in part on the visual information and the electrical information.

21. The method of claim 19 wherein the electronic device is of a type that belongs to a group of different electronic device types previously purchased by a plurality of kiosks, wherein each of the different electronic device types has an individual price, and wherein the weighted average price is based at least in part on the individual prices of the different electronic device types in the group.

22. The method of claim 19 wherein the electronic device is of a type that belongs to a group of different electronic device types previously purchased by a plurality of kiosks, and wherein the weighted average price is based at least in part on the individual quantities of the different electronic device types previously purchased by the plurality of kiosks.

23. The method of claim 19 wherein the electronic device is of a type that belongs to a group of different electronic device types previously purchased by a plurality of kiosks, wherein each of the different electronic device types has an individual price, and wherein the weighted average price is based at least in part on the individual quantities of the different electronic device types previously purchased by the plurality of kiosks and the individual prices of the different electronic device types in the group.

24. A computer readable storage medium storing instructions configured to, when executed by a computing device, cause the computing device to perform operations for purchasing electronic devices from users, the operations comprising:
receiving an electronic device from a user;
inspecting the electronic device;
based on the inspection, determining a group that the electronic device belongs to, wherein the group includes a plurality of different electronic devices having similar features;
determining an average price based on the group; and
offering the user the average price for the electronic device.

25. The computer readable storage medium of claim 24:
wherein inspecting the electronic device includes at least one of visually inspecting or electrically inspecting the electronic device;
wherein the group of similar electronic devices is comprised of at least a first quantity of a first type of electronic device and a second quantity of a second type of electronic device,
wherein the first type of electronic device has a first price and the second type of electronic device has a second price, and
wherein determining the average price includes generating a weighted average price based at least in part on the first and second quantities and the first and second prices.

26. The computer readable storage medium of claim 24:
wherein the group of similar electronic devices is comprised of at least a first quantity of a first type of electronic device and a second quantity of a second type of electronic device,
wherein the first type of electronic device has a first price and the second type of electronic device has a second price, and
wherein determining the average price includes determining a weighted average price according to the following formula:
$$WAP = \frac{\sum {( \$ \times Qty )}_{D 1} + {( \$ \times Qty )}_{D 2} + … {( \$ \times Qty )}_{Dn}}{\sum {Qty}_{D 1} + {Qty}_{D 2} + … {Qty}_{D n}}$$
where $_{D1} is the first price, $_{D2} is the second price, $_{Dn} is a price of an n^{th} electronic device in the group, Qty_{D1} is the first quantity, Qty_{D2} is the second quantity, and Qty_{Dn} is a quantity of the n^{th} electronic device in the group.

27. The computer readable storage medium of claim 24 wherein the kiosk is one of a plurality of electronic device recycling kiosks, and wherein the operations further comprise:
receiving a first quantity of a first type of electronic device via the plurality of electronic device recycling kiosks;
receiving a second quantity of a second type of electronic device via the plurality of electronic device recycling kiosks; and
determining the average price based at least in part on the first and second quantities.

28. The computer readable storage medium of claim 24 wherein the kiosk is one of a plurality of electronic device recycling kiosks, and wherein the operations further comprise:
receiving a first quantity of a first type of electronic device via the plurality of electronic device recycling kiosks;
paying a first price to individually purchase each of the first type of electronic device in the first quantity;
receiving a second quantity of a second type of electronic device via the plurality of electronic device recycling kiosks; and
paying a second price to individually purchase each of the second type of electronic device in the second quantity, wherein determining the average price includes determining a weighted average price based at least in part on the first and second quantities and the first and second prices.

29. A system for purchasing electronic devices from consumers, the system comprising:
an inspection area for receiving electronic devices;
an imaging component operably disposed in relation to the inspection area to visually inspect electronic devices received therein;
a processing device operably connected to the imaging component; and
a computer-readable medium that contains computer-executable instructions configured to cause the processing device to operate the system according to a method that comprises:
receiving an electronic device in the inspection area;
obtaining visual information about the electronic device by use of the imaging component;
at least partially identifying the electronic device based at least in part on the visual information;
determining a level of confidence in the identification of the electronic device;
when the level of confidence is above a threshold, offering to purchase the electronic device for a set price; and
when the level of confidence is below the threshold, offering to purchase the electronic device for a weighted average price.

30. The system of claim 29 wherein the method further comprises:
determining a group that the electronic device belongs to based at least in part on the visual information, wherein the group includes a plurality of different electronic devices having similar features; and
generating the weighted average price based on the group.

31. The system of claim 29 wherein the method further comprises:
determining a group of similar electronic devices that the electronic device belongs to based at least in part on the visual information, wherein the group of similar electronic devices is comprised of at least a first quantity of a first type of electronic device and a second quantity of a second type of electronic device, wherein the first type of electronic device has a first price and the second type of electronic device has a second price, and
generating the weighted average price based at least in part on the first and second quantities and the first and second prices.

32. The system of claim 29, further comprising an electrical connector operably connected to the processing device and configured to be temporarily connected to the electronic device, wherein the method further comprises obtaining electrical information about the electronic device via the electrical connector, wherein at least partially identifying the electronic device includes at least partially identifying the electronic device based at least in part on the visual information and the electrical information.

33. The system of claim 29 wherein the inspection area is configured to receive mobile phones, and wherein the system further comprises a consumer operated kiosk, wherein at least the inspection area and the imaging component are operably contained within the kiosk.

34. The system of claim 29 wherein the inspection area is configured to receive computing devices, and wherein the system further comprises a consumer operated kiosk, wherein at least the inspection area and the imaging component are operably contained within the kiosk.

35. The system of claim 29 further comprising a countertop-mounted machine, wherein at least the imaging component and the processing device are operably coupled to the countertop machine.
